(19) United States
(12) Patent Application Publication
(10) Pub. No.: US 2015/0077365 A1
(43) Pub. Date: Mar. 19, 2015

(54) SYSTEM, INFORMATION PROCESSING APPARATUS, AND IMAGE DISPLAY METHOD

(71) Applicant: Fumihiro SASAKI, Tokyo (JP)

(72) Inventor: Fumihiro SASAKI, Tokyo (JP)

(73) Assignee: RICOH COMPANY, LTD., Tokyo (JP)

(21) Appl. No.: 14/477,050

(22) Filed: Sep. 4, 2014

(30) Foreign Application Priority Data
Sep. 13, 2013 (JP) 2013-191152

(51) Int. Cl. G06F 3/041; G06F 3/147; G06F 3/14

(52) U.S. Cl. CPC G06F 3/0418; G06F 3/0412; G06F 3/1446; G06F 3/147
USPC 345/173

(57) ABSTRACT

A system includes first and second information processing apparatuses each having a display device. The first information processing apparatus includes a first display controller controlling the first display device to display a display target, a specified position detector detecting a specified position of the first display device, a receiver receiving movement of the display target, a movement information calculator calculating movement information of the display target, a determiner determining whether to transmit display target information and the movement information based on the calculated movement information, and a transmitter transmitting the display target information and the movement information when the determiner has determined to transmit the display target information and the movement information. The second information processing apparatus includes a second display controller controlling the second display device to display the display target based on the display target information and the movement information transmitted by the transmitter.

### BACKGROUND OF THE INVENTION

1. Field of the Invention

The disclosures discussed herein relate to a system to which two or more information processing apparatuses having respective display devices with screens aligned in an array to display an image and capable of communicating with one other are connected.

2. Description of the Related Art

Whiteboards are frequently used as a technique for improving intellectual productivity of the conferences and meetings. Such whiteboards allow one or more participants to write and display information. Moreover, to prevent one's ideas and thoughts from being interrupted due to the limited size of the whiteboard, an attempt has been made to make the entire wall of the conference room or the like with writable or paintable materials so as to overcome the limited size of the whiteboard. With the above technique, the participants of the conference or the like may write their ideas and thoughts without being interrupted by using the entire wall of the conference room as a writing and displaying space.

Meanwhile, there are known in the art electronic whiteboards implemented by a touch panel display to overcome the limited size of the whiteboard. In such an electronic white board, the touch panel incorporates content of user's writing on the whiteboard by using positional information detected by the touch panel, the incorporated content being reflected on a screen uniformly formed with the touch panel.

Hence, the user may be able to draw or display characters and the like by using the touch panel as well as allowing the touch panel to electronically incorporate the content of the drawing in a manner similar to the whiteboard. The user may be able to redisplay or reprocess the electronically incorporated content of the writing on the whiteboard by the extensive application of the above technique.

However, the display size of the touch panel is physically limited. Hence, compared to the entire wall of the conference room or the like serving as a writable or paintable whiteboard, the touch panel display may have a functional limitation of not acquiring a full view of the display. It is possible for the user to handle the display size as semi-infinite space by using a screen scroll function. However, the scrolling may physically interrupt the user's thinking.

Japanese Laid-open Patent Publication No. 2003-271118 (hereinafter referred to as “Patent Document 1”), for example, proposes a multi-display technology to acquire a full view with wider area of the display. In this technology, a number of touch panels are aligned in an array to display a full view. Patent Document 1 discloses a method for specifying positions of plural image display devices by receiving an input of each of the positions of the image display devices when a multi-screen display environment is constructed with the image display devices.

In Patent Document 1, a multi-display is implemented by aligning plural touch panels in an array, which provides advantages of allowing the entire wall of a conference room or the like to serves in a whiteboard and allowing the plural touch panels to serves in a whiteboard. Further, in this technology, it is possible to acquire a full view similar to that obtained with the entire wall of the conference room or the like that serves in the whiteboard by increasing the number of touch panels.

However, the related art multi-display technology does not provide an interlocking function between the touch panel displays. Hence, display lag (delay in displaying) is frequently observed across the plural displays that display a drawing object, which may adversely affect the capability of intuitive operations on a touch panel that is otherwise the primary advantage of the touch panel.

### RELATED ART DOCUMENT

### Patent Document

Patent Document 1: Japanese Laid-open Patent Publication No. 2003-271118

### SUMMARY OF THE INVENTION

Accordingly, it is a general object in one embodiment of the present invention to provide a panel system capable of preventing display lag of an image displayed across plural displays in the panel system having the displays aligned in an array that substantially obviates one or more problems caused by the limitations and disadvantages of the related art.

In one aspect of the embodiment, there is provided a system that includes a plurality of information processing apparatuses each having a display device configured to display an image, at least two of the information processing apparatuses being capable of communicating with each other. In the system, a first information processing apparatus includes a first display controller configured to control a first display device of the first information processing apparatus to display a display target; a specified position detector configured to detect a position specified by a specifying operation with respect to a display surface of the first display device of the first information processing apparatus; a receiver configured to receive movement of a display position of the display target displayed on the first display device of the first information processing apparatus based on the position detected by the specified position detector; a movement information calculator configured to calculate movement information associated with the movement of the display position of the display target received by the receiver; a determiner configured to determine whether to transmit display target information associated with the display target and the movement information of the display target to a second information processing apparatus based on the movement information calculated by the movement information calculator; and a transmitter configured to transmit the display target information and the movement information of the display target to the second information processing apparatus when the determiner has determined to transmit the display target information and the movement information of the display target to the second information processing apparatus; and the second information processing apparatus includes a second display controller configured to control a second display device of the second information processing apparatus to display the display target based on the display target information and the movement information of the display target transmitted by the transmitter.

Other objects, features and advantages of the present invention will become more apparent from the following detailed description when read in conjunction with the accompanying drawings.

### BRIEF DESCRIPTION OF THE DRAWINGS

FIGS. 1A to 1E are diagrams illustrating an example in which an intuitive operation is interrupted in a related art technology;

FIGS. 2A to 2D are schematic diagrams illustrating an example of a panel system according to an embodiment;

FIG. 3 is a diagram illustrating a configuration example of a panel system composed of plural touch panels;

FIG. 4 is a diagram illustrating another configuration example of a panel system composed of plural touch panels;

FIGS. 5A to 5D are diagrams illustrating examples of images (patterns) that the touch panels display for detecting their disposed positions;

FIG. 6 is a diagram illustrating examples of images (patterns) that the touch panels display for detecting their disposed positions;

FIG. 7 is a diagram illustrating a hardware configuration example of a touch panel;

FIG. 8 is a software functional block diagram illustrating an example of software functionality of the touch panel;

FIG. 9 is a diagram illustrating an example of a menu screen displayed by an application layer;

FIG. 10 is a schematic diagram illustrating an example of page data;

FIG. 11 is a schematic diagram illustrating an example of stroke table data;

FIG. 12 is a schematic diagram illustrating an example of coordinates array data;

FIGS. 13A and 13B are schematic diagrams illustrating examples of graphic data;

FIG. 14 is a diagram illustrating an example of transmission data transmitted by a touch panel configured to report movement of an object to a moving destination touch panel;

FIGS. 15A to 15C are diagrams illustrating examples of object transfer corresponding to command information;

FIG. 16 is a diagram illustrating an example of moving vectors;

FIGS. 17A to 17E are diagrams illustrating examples of a transfer triggering area;

FIGS. 18A and 18B are diagrams illustrating an example of a relationship between a position and a threshold of an object within a transfer triggering area;

FIG. 19 is a diagram illustrating an example of determination of a transfer destination touch panel;

FIG. 20 is a diagram illustrating an example of determination of display timing of an object made by the transfer destination touch panel;

FIG. 21 is a flowchart illustrating an example of a process in which an object resource manager determines whether to transfer an object;

FIGS. 22A and 22B are diagrams illustrating configuration examples of panel systems, one with two projectors and the other with two rear projections;

FIG. 23 is a flowchart illustrating an example of a process in which a transfer source touch panel transfers an object; and

FIG. 24 is a flowchart illustrating an example of a process in which a transfer destination touch panel receives the transferred object.

### DETAILED DESCRIPTION OF THE PREFERRED EMBODIMENTS

In the following, a description is given of embodiments of the present invention with reference to the accompanying drawings.

### Supplemental Illustration of Related Art Technology

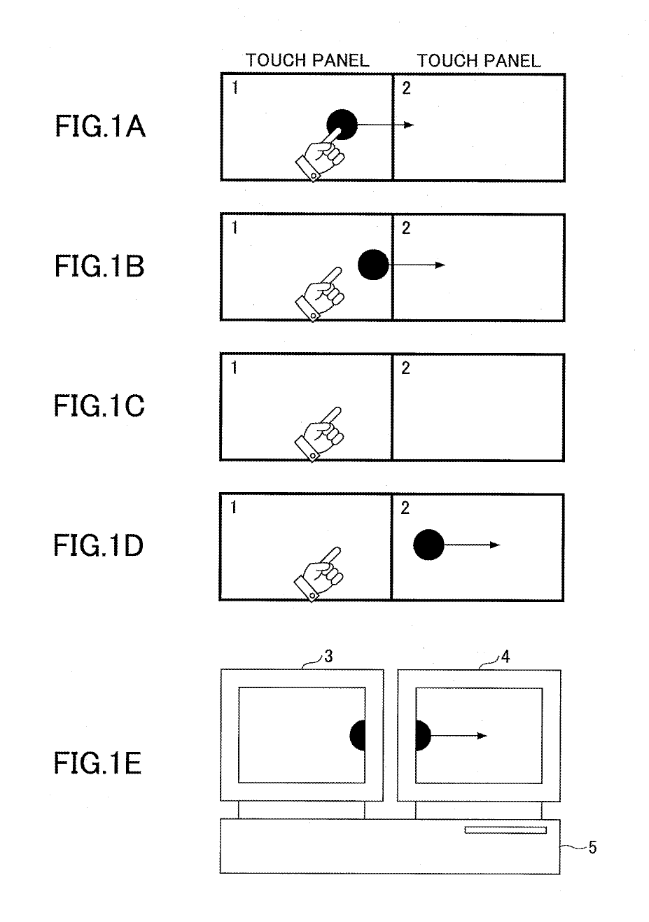

FIGS. 1A to 1E are diagrams illustrating an example in which an intuitive operation is inhibited in a related art technology. In this related art example, two touch panels are coupled. An illustration is given of a case where a user moves an object (illustrated as a circle) displayed on a touch panel 1 to a touch panel 2. Note that an object indicates an integrated drawing object composed of one stroke, plural strokes with overlaps, or plural strokes drawn within a predetermined distance and a predetermined time, a graphic, or the like.

In FIG. 1A, a user selects an object on a touch panel 1, and flicks or drags the object toward a direction of a touch panel 2.

In FIG. 1B, the touch panel 1 draws the object until coordinates of the object reach coordinates of an end of the touch panel 1, and requests the touch panel 2 to display the object.

In FIG. 1C, the touch panel 2 receives data (e.g., coordinates, moving velocity, moving direction, shape, and color) of the object to calculate a current position of the object. Hence, time lag (delay) occurs in an interval between receiving the object and displaying the object.

In FIG. 1D, the touch panel 2 displays the object when it is ready.

As described above, simply connecting two touch panels 1 and 2 does not allow the touch panel 2 to smoothly display the object without delay or interruption when the touch panel 1 transfers the object to the touch panel 2. For example, as illustrated in FIG. 1C, there is latency where no object is displayed on the touch panels 1 and 2 until the touch panel 2 displays the object.

To prevent such latency, the touch panel 2, which is requested by the touch panel 1 to display the object, may be caused to display the object at an end of the touch panel 2 while the touch panel 1 still displays the object. However, in this case, the position of the object may change or the object appears temporarily stopped. Hence, the object does not appear to be transferred smoothly without delay or interruption from the touch panel 1 to the touch panel 2.

Note that the object may be transferred without the above disadvantageous display effect such as delay or interruption when there is a controller configured to control these two touch panels as a whole. FIG. 1E illustrates an example of a personal computer (PC) 5 that is connected to two displays 3 and 4. In this case, the PC 5 internally handles display areas of the two displays 3 and 4 as one screen. Thus, when a user moves an object between the two displays 3 and 4, the PC 5 does not need to transfer the object from the display 3 to the display 4 even though the displays 3 and 4 are physically separate entities. Hence, there may be no time lag in displaying the object between the displays 3 and 4 when displaying the object extends across the displays 3 and 4.

The following embodiments may provide a panel system capable of transferring an object between plural touch panels smoothly without being provided with a controller configured to control the touch panels as a whole to display an image.

### First Embodiment

### Outline of Panel System

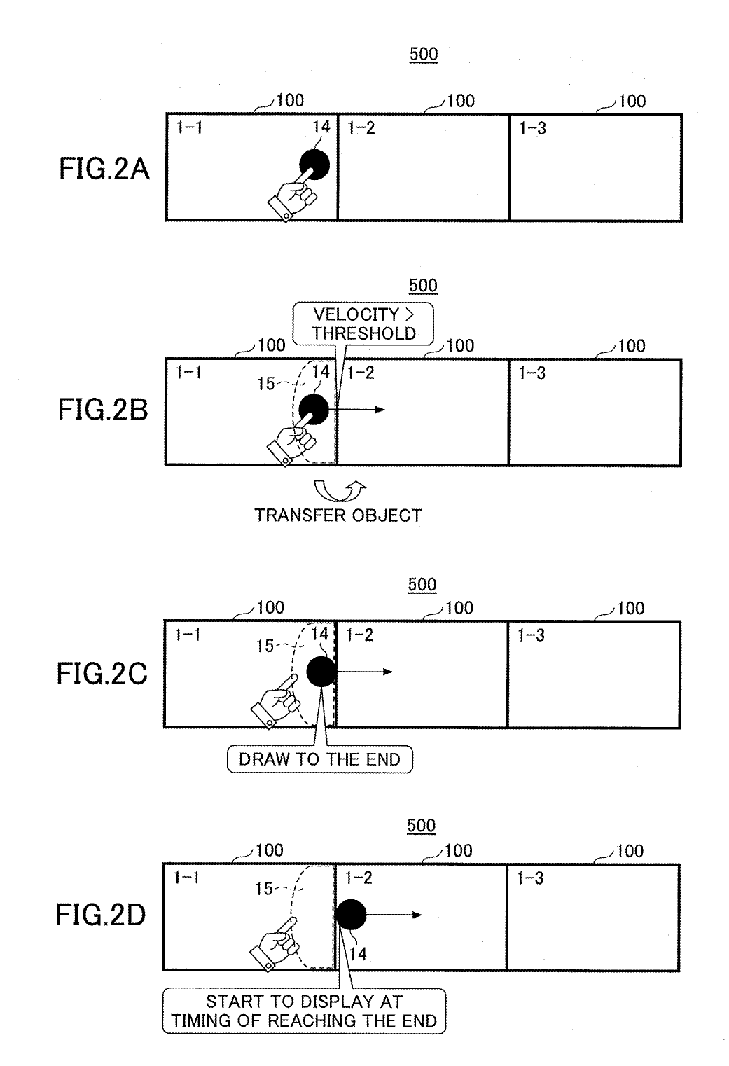

FIG. 2A is a schematic diagram illustrating an example of a panel system 500 according to an embodiment. Three touch panels 100 (hereinafter respectively referred to touch panels 1-1, 1-2, and 1-3) are arranged in an array of one row and three columns. It is assumed that an object 14 (an example of a “display object” in the claims) displayed on the touch panel 1-1 is flicked or dragged by a pointing device (hereinafter abbreviated as a “PD”) to be moved to the touch panel 1-2. Note that the PD may be a user's finger or a pen-shaped pointing device.

It may be particularly important for a user to move the object 14 from the touch panel 1-1 to the touch panel 1-2 smoothly without delay or interruption (with little time lag) when the user moves the object 14 relatively fast (with a relatively high velocity). When the user moves the object 14 slowly, the object 14 appears to move consistently from the touch panel 1-1 to the touch panel 1-2 without delay or interruption, despite the fact that the touch panel 1-2 displays the object 14 at a position where the user has touched with the PD after the object 14 has reached a bezel (also called a “frame” or a “rim”) of the touch panel 11. Moreover, when the object 14 is moved to the touch panel 1-2 against the user's intention to move the object merely within the touch panel 1-1 (i.e., when the user slowly moves the object 14 to the end of the touch panel 1-1), the user may perceive the movement inconsistently.

Accordingly, in the following embodiments, an illustration is given of a case, based on the assumption in which the object 14 that is moving relatively fast is transferred from the touch panel 1-1 to the touch panel 1-2.

FIGS. 2B to 2D are diagrams illustrating an example in which the object 14 is transferred between the touch panels 100 (1-1, 1-2, and 1-3). As illustrated in FIG. 2B, the touch panel 100 sets a transfer triggering area 15 in this embodiment. The transfer triggering area 15 (an example of a “determination area” in the claims) serves in an area by which the touch panel 1-1 determines whether to transfer the object 14 to the adjacent touch panel 1-2.

The touch panel 1-1 determines to transfer the object 14 in a case where the selected object 14 is within the transfer triggering area 15, and the magnitude (velocity) of the moving vector is the threshold or above. When the touch panel 1-1 has determined to transfer the object 14, the touch panel 1-1 transfers the object 14 to the touch panel 1-2. The moving vector is described later; however, the moving vector is an example of moving object information in the claims.

Thereafter, the touch panel 1-1 continuously draws the object 14 to the end of the touch panel 1-1 as illustrated in FIG. 2C. In this interval, the touch panel 1-2 receives data (e.g., coordinates, moving velocity, moving direction, shape, and color, which serves in transmission data and graphic data in this embodiment) of the object and calculates a display position of the object.

As illustrated in FIG. 2D, the touch panel 1-2 starts to display the object 14 at a timing at which the object 14 reaches an end of the touch panel 1-1. Note that in this embodiment, the end of the touch panel 1-1 is treated as the end of the touch panel 1-2. However, the end of the touch panel 1-1+α may be treated as the end of the touch panel 1-2.

As described above, in the panel system 500 according to the first embodiment, even though the panel system 500 is not provided with a controller configured to control the touch panels as a whole, the object 14 may be transferred between the touch panels smoothly without delay or interruption by transferring the object 14 within the transfer triggering area 15 to the touch panel 1-2 before the object 14 reaches the end of the touch panel 1-1.

### Touch Panel

There are many types of the touch panels 100 such as a resistive touch panel, an electrostatic capacitance touch panel, an electromagnetic induction touch panel, an ultrasonic surface-acoustic-wave touch panel, an infrared scanner touch panel, and an infrared radiation shielding triangulation touch panel.

The resistive touch panel is configured to detect an operation position based on electrical conductivity generated from the pressed surface. The resistive touch panel is configured to be handled not only by a user's finger wearing or without wearing a glove but is also configured to be handled by a pen. The electrostatic capacitance touch panel is configured to detect an operation position by generating an electric field over the surface of the panel to detect a change in the surface charge of the touched part. The electrostatic capacitance touch panel is not configured to be handled by a pen or a user's finger wearing a glove. The electromagnetic induction touch panel is configured to detect an operation position based on detected electromagnetic energy generated from a sensor on the panel side when a dedicated pen presses a screen of the touch panel. The electromagnetic induction touch panel is not configured to be handled without the dedicated pen. The ultrasonic surface-acoustic-wave touch panel is configured to detect an operation position based on a change in an acoustic wave on a screen of the touch panel due to absorption in a pressed part of the screen when the acoustic wave is applied to the entire surface of the touch panel. The ultrasonic surface-acoustic-wave touch panel is not configured to be handled by a pen or a user's finger wearing a glove. The infrared scanner touch panel is configured to detect an operation position where light is shield by being pressed with a pen or a user's finger when light emitters and light receivers are disposed around the touch panel. The infrared scanner touch panel is configured to be handled not only by a user's finger wearing or without wearing a glove but also by a pen. The infrared radiation shielding triangulation touch panel is configured to detect an operation position where infrared rays are intercepted by the triangulation. The infrared radiation shielding triangulation touch panel is configured to be handled not only by a user's finger wearing or without wearing a glove but also by a pen.

There are a great number of additional types of the touch panels 100 that are derived from those described above. The touch panel 100 of the first embodiment may be any of the above-described types. Moreover, it is not necessary that the position detection methods of the touch panels that form the panel system 500 are identical.

### Configuration Example of Panel System

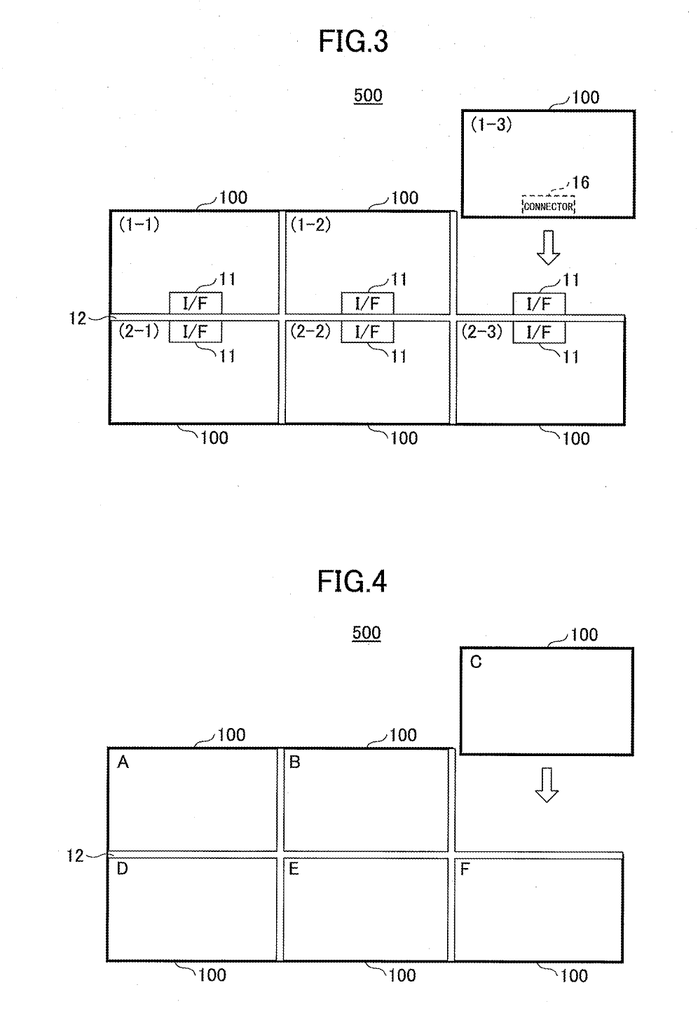

FIG. 3 is a diagram illustrating a configuration example of the panel system 500 composed of plural touch panels. A bracket 12 for use in the panel system 500 is disposed in parallel with a wall (preferably on the entire surface of the wall) of a conference room or the like. In FIG. 3, the touch panels 100 are arranged in an array of two rows and three columns.

The bracket 12 includes I/Fs 11 for attaching connectors of the touch panels 100 to respective places of the bracket 12. Each of the I/Fs 11 is provided with a unique I/F number in advance, and the I/Fs 11 are electrically connected to one another via wired or wireless communications.

Each of the touch panels 100 attached to the corresponding place of the bracket 12 via the IF reads a corresponding one of I/F numbers of the IFs. Each I/F number may include positional information in the panel system 500, and may be represented by the number enclosed by brackets “( )” as illustrated in FIG. 3. That is, each of the I/F numbers matches a corresponding one of the places for the touch panels 100 in the bracket 12. Each of the touch panels 100 specifies its position in the panel system 500 based on a corresponding one of the I/F numbers. For example, the touch panel 1-1 attached to the I/F 11 having the I/F number “1-1” specifies its own position being “1-1”=(1^{st} row, 1^{st} column), and determines itself being disposed on a upper left corner of the panel system 500. Similarly, the touch panel 1-2 specified by the I/F number “1-2 is disposed on the right-hand side of the place to which the touch panel 1-1 specified by the I/F number “1-1 is attached. The touch panels 100 may be identified by the respective I/F numbers. Hence, each of the touch panels 100 may be able to transfer an object to the adjacent touch panel by identifying other touch panels 100 with the respective I/F numbers.

The bracket 12 connects between the touch panels in a “one vs n” configuration or in a bus configuration. For example, the touch panel 1-1 may be in communication with the touch panels 1-2, 1-3, 2-1, 2-2, and 2-3. Likewise, each of the touch panels 1-2, 1-3, 2-1, 2-2, and 2-3 is connected to other touch panels in the “one vs n” configuration. Note that each of the touch panels is not necessarily connected in the “one vs n” configuration. Each of the touch panels may be connected only to the touch panels to which that touch panel may possibly transfer the object. For example, from the view point of the touch panel 1-1, the touch panels 1-2, 2-1, and 2-2 are those to which the touch panel 1-1 may have possibility of transferring the object 14.

As illustrated in FIG. 3, when a user slides the touch panel 1-3 to attach the touch panel 1-3 to the bracket 12, a connector 16 and I/F 11 are electrically connected. It is preferable that the connector 16 have a power supply function. Since the touch panel 1-3 communicates with other touch panels 1-1, 1-2, 2-1, 2-2, and 2-3 via its I/F 11 by broadcasting, the touch panels 1-1, 1-2, 2-1, 2-2, and 2-3 connected their I/Fs 11 may be able to detect that the touch panel 1-3 is attached to the bracket 12 via the corresponding I/F 11. The touch panels 100 may be configured such that the touch panels 100 themselves do not communicate one another, but touch panels 100 may be configured such that each of the I/Fs 11 connected to the touch panels 100 detects that that touch panel 100 has been attached to the corresponding I/F 11, and the I/F 11 attached to the touch panel 100 reports that the touch panel 100 has been attached to the I/F 11 to other touch panels 100.

FIG. 4 is a diagram illustrating another configuration example of a panel system 500 composed of plural touch panels 100. In the following, a description is given of a case where the bracket 12 does not have functionality of identifying the attached positions of the touch panels 100. Specifically, an illustration is given of the panel system 500, the bracket 12 does not have any I/Fs 11; that is, in the panel system 500 in which the bracket 12 is provided with no communications function. In this case, each touch panel 100 is unable to specify the position of the touch panel 100 itself based on the I/F number. Hence, each touch panel 100 specifies the position of the touch panel 100 itself using a unique identifier ID of the touch panel 100. Note that the touch panel may be slidably attached to the bracket 12 as illustrated by the touch panel 1-3 in FIG. 3, which is the same as each touch panel being provided with an I/F 11. In this case, the connector 16 included in each of the touch panels 100 may be used for supplying power.

The touch panels 100 exchange their IDs with one another via wireless communications. Examples of specifications of the wireless communications are as follows.

Wireless LAN (infrastructure mode)

Wireless LAN (ad-hoc mode)

Bluetooth (registered trademark), etc.

In the infrastructure mode, six touch panels 100 connected to an access point form one network. The six touch panels 100 are manually or automatically provided with non-overlapped (i.e., unique) IP addresses. Hence, each of the touch panels 100 is capable of acquiring IP addresses and MAC addresses of other touch panels 100 by sending a Ping command to the touch panels 100 having the same network address (i.e., connected to the same access point). Thus, the IP addresses and MAC addresses may be used as identifiers IDs in this case. Further, any numbers, the alphabet, symbols, and characters may be combined to form an identifier ID. For example, a touch panel having an identifier ID called “A” may be able to detect touch panels 100 having respective identifiers IDs B, C, D, E, and F.

In the ad-hoc mode, a pair of touch panels 100 forms one network. Likewise, each of the touch panels 100 is manually or automatically provided with a non-overlapped (i.e., unique) IP address, each of the pair of the touch panels may mutually acquire its counterpart IP address and MAC address. Thus, the IP addresses and MAC addresses may be used as the identifiers IDs similar to those described the above. For example, the touch panel 100 having the identifier “A” may be able to detect the presence of the touch panel 100 having an identifier “B” by communicating with the touch panel 100 having the identifier “B”. Subsequently, the touch panel 100 having the identifier “A” may be able to detect the presence of the touch panels 100 having respective identifiers IDs C, D, E, and F by communicating with the touch panels 100 having the respective identifiers IDs C, D, E, and F. Likewise, the touch panel 100 having the identifier “A” may be able to detect the presence of other touch panels 100 by communicating with the other touch panels 100 via the ad-hoc mode communications.

In the Bluetooth case, once pairing is performed, one of the touch panels 100 serving as a master and the other five touch panels 100 serving as slaves may form a piconet. Each slave is identified by a logical address. Hence, the touch panel 100 serving as a master may be able to detect the presence of other touch panels 100 identified by the logical addresses.

Hence, even though each of the touch panels 100 may be able to detect the presence of other touch panels 100 by the respective identifiers ID, the touch panels 100 fail to detect the disposed positions of the touch panels 100 themselves. Thus, each of the touch panels 100 is configured to detect its disposed place as follows.

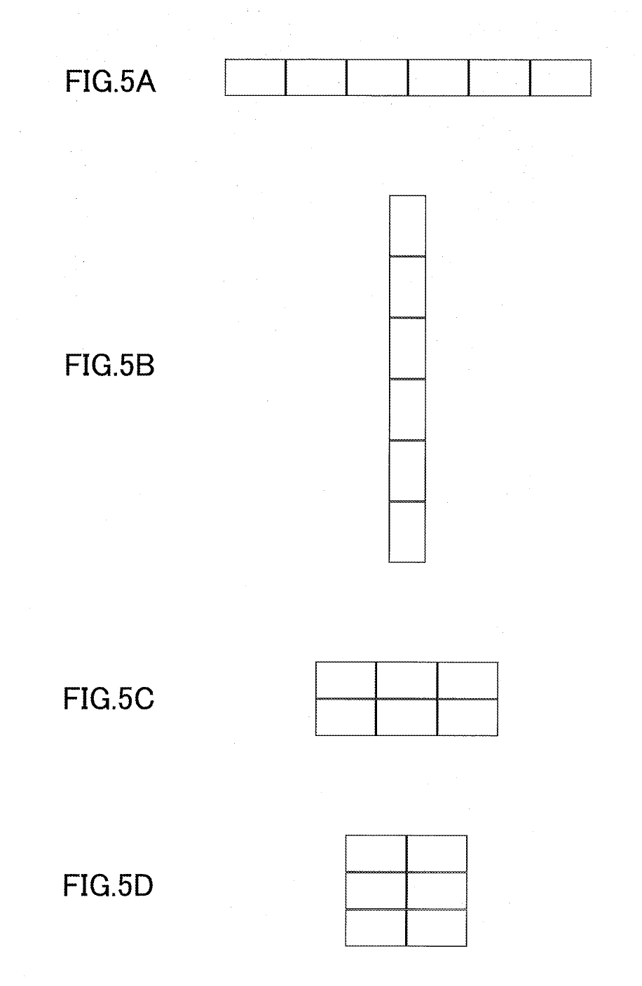

FIGS. 5A to 5D are diagrams illustrating examples of images (patterns) that the touch panels 100 display for detecting their disposed positions. When a user performs a predetermined operation on the touch panel 100, the touch panel 100 displays a selecting screen of disposed patterns such as those illustrated in FIGS. 5A to 5D. Since the number of touch panels 100 is specified as six as a result of exchanging the identifiers IDs, each of the touch panels 100 displays a list of the disposed patterns of the six touch panels 100. Alternatively, the user may specify the number of the touch panels 100.

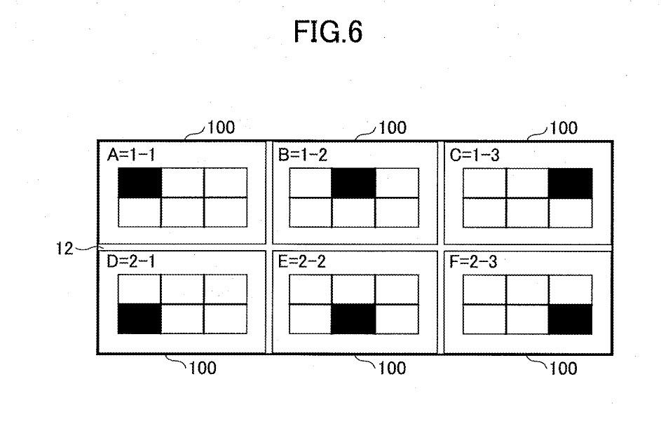

FIG. 5A illustrates a 1×6 disposed pattern, FIG. 5B illustrates a 6×1 disposed pattern, FIG. 5C illustrates a 2×3 disposed pattern, and FIG. 5D illustrates a 3×2 disposed pattern. The user selects one of the above disposed patterns that is the same as a disposed pattern of the bracket 12. In this embodiment, the user selects the disposed pattern of FIG. 5C. The user selects the disposed pattern of FIG. 5C displayed on each of the touch panels 100. Alternatively, the user may select the disposed pattern displayed on one of the touch panels 100, and the touch panel 100 that received the selection of the disposed pattern may transmit the selected disposed pattern to other five touch panels 100. FIG. 6 is a diagram illustrating examples of images (patterns) that the touch panels 100 display for detecting their disposed positions. Each of the touch panels 100 specifies a corresponding one of the disposed positions in the panel system 500 by using the disposed pattern selected from FIGS. 5A to 5D.

Initially, each of the touch panels 100 displays the disposed pattern that the user has selected from FIGS. 5A to 5D. The user touches a place corresponding to the disposed position of a remarked one of the touch panels 100 disposed within the bracket 12. Specifically, the user touches an upper left position (a shaded area) of the disposed pattern displayed on the touch panel 100 having the identifier ID “A”. The user touches an upper middle position (a shaded area) of the disposed pattern displayed on the touch panel 100 having the identifier ID “B”. The user touches an upper right position (a shaded area) of the disposed pattern displayed on the touch panel 100 having the identifier ID “C”. The user touches a lower left position (a shaded area) of the disposed pattern displayed on the touch panel 100 having the identifier ID “D”. The user touches a lower middle position (a shaded area) of the disposed pattern displayed on the touch panel 100 having the identifier ID “E”. The user touches a lower right position (a shaded area) of the disposed pattern displayed on the touch panel 100 having the identifier ID “F”.

Each of the touch panels 100 may be able to specify a disposed position (disposed place) of itself in the bracket 12. That is, the touch panel having the identifier ID “A” is specified as being disposed at a place indicated by “1-1”, the touch panel having the identifier ID “B” is specified as being disposed at a place indicated by “1-2”, the touch panel having the identifier ID “C” is specified as being disposed at a place indicated by “1-3”, the touch panel having the identifier ID “D” is specified as being disposed at a place indicated by “2-1”, the touch panel having the identifier ID “E” is specified as being disposed at a place indicated by “2-2”, and the touch panel having the identifier ID “F” is specified as being disposed at a place indicated by “2-3”.

### Configuration Example of Touch Panel

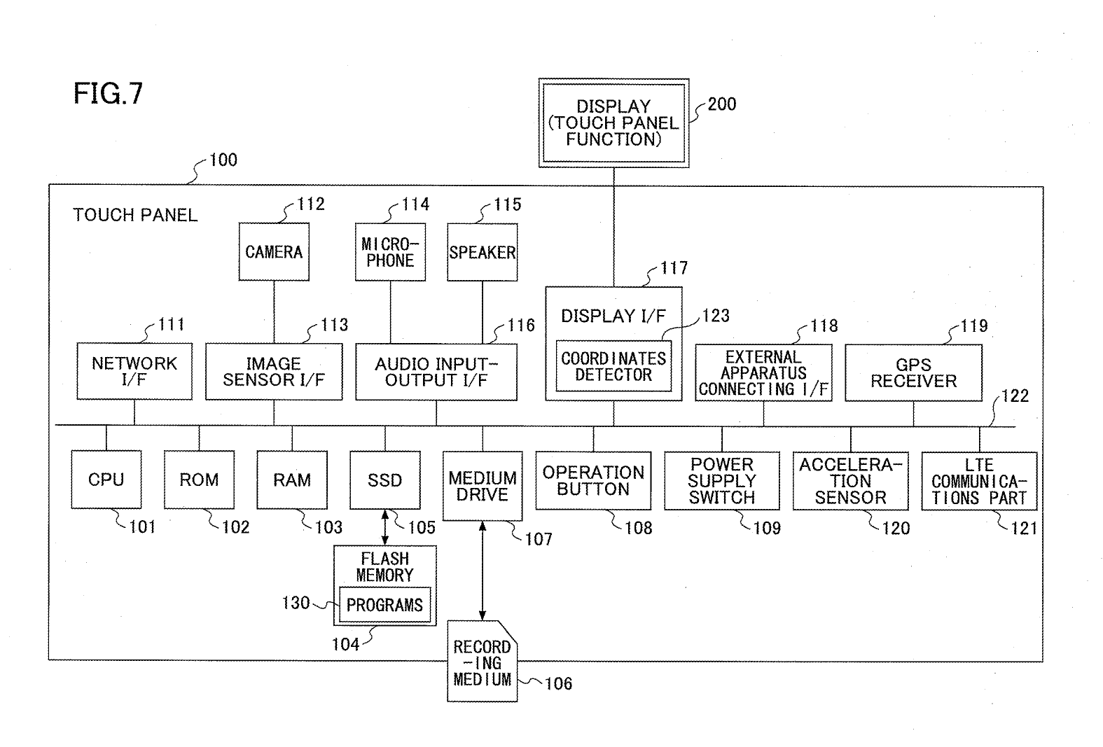

FIG. 7 is a diagram illustrating a hardware configuration example of the touch panel 100. The touch panel 100 is an example of an information processing apparatus provided with a coordinates detecting function. The touch panel 100 may be any information processing apparatus capable of detecting coordinates of a position specified on a display device of the touch panel 100. Specific examples of the touch panel 100 include a tablet, a tablet PC, a note PC, an Ultrabook, a display detached from the note PC, an electronic whiteboard and the like.

The touch panel 100 includes a CPU 101 configured to control operations of the entire touch panel 100, a ROM 102 storing programs such as initial program loader (IPL), a RAM 103 serving as a work area of the CPU 101, a flash memory 104 storing various types of data such as mobile terminal programs 130 and map data, a solid state drive (SDD) 105 configured to control reading or writing of various types of data with respect to a flash memory 104 based on the control of the CPU 101, a medium drive 107 configured to control reading or writing (storing) of data with respect to a recording medium 106 such as flash memory, an operations button 108 configured to receive various operations with respect to the touch panel 100, a power supply switch 109 configured to switch ON/OFF of the power supply of the touch panel 100, and a network interface (I/F) 111 for transmitting data via a wired or wireless communications network.

The touch panel 100 further includes a built-in camera 112 configured to acquire image data by imaging a subject based on the control of the CPU 101, an image sensor I/F 113 configured to control driving of the built-in camera 112, a built-in microphone 114 configured to input sound or voice, a built-in speaker 115 configured to output sound or voice, an audio input-output I/F 116 configured to process input and output of audio signals between the microphone 114 and the speaker 115 based on the control of the CPU 101, a display I/F 117 configured to transmit image data to a display 200 based on the control of the CPU 101, an external apparatus connecting I/F 118 configured to connect various types of external apparatuses, a GPS receiver 119 configured to receive radio waves from a GPS satellite to detect a position, an acceleration sensor 120 configured to detect acceleration generated in the touch panel 100, a LTE communications part 121 configured to perform audio communications and data communications via a mobile telephone network, and a bus line 122 such as an address bus or data bus for connecting the above-described components illustrated in FIG. 7.

The display 200 is made of liquid crystal or organic EL, and serves in a drawing area for a user to draw by his/her inputting coordinates with PD as well as serving as a display area to display the drawn content. The display 200 is configured to display a menu or the like as a whiteboard. The display I/F 117 includes a coordinates detector 123 configured to detect coordinates of the position of the PD that has touched the display 200.

The camera 112 includes lenses or a solid-state image sensor configured to convert an image (video) of a subject into electronic data by converting light into electric charges. Examples of the solid-state image sensor include a complementary metal oxide semiconductor (CMOS) or a charge coupled device (CCD).

Various external devices and apparatuses may be attached to the external apparatus connecting I/F 118 via a universal serial bus (USB) cable and the like. For example, the external apparatus connecting I/F 118 may be used for connecting to the I/F 11 and a close range wireless communications device such as Bluetooth.

Further, the flash memory 104 stores programs 130. The programs 130 may also be called “applications (APP)”. The programs 130 may be downloaded from a not-illustrated server via the network I/F 111.

Note that the recording medium 106 is configured to be removable from the touch panel 100. Further, when the programs 130 is stored in nonvolatile memory configured to read or write data based on the control of the CPU 101, the programs 130 may be recorded in the recording medium 106 and distributed in a form of the recording medium 106.

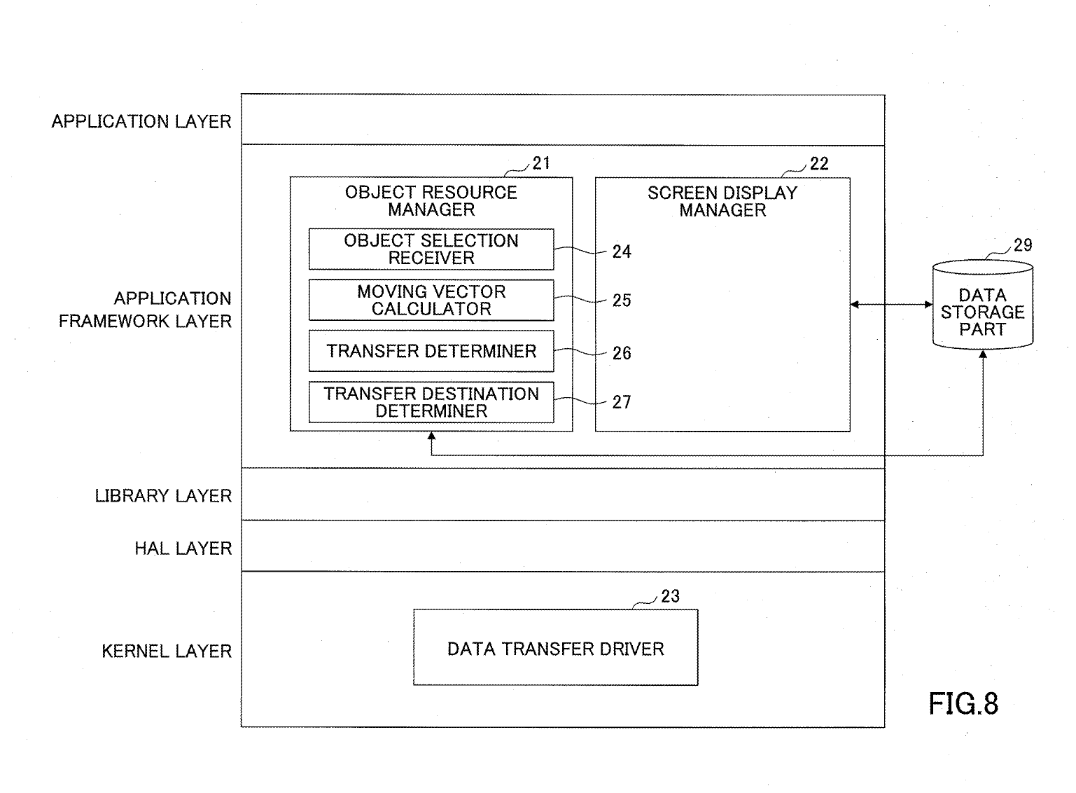

FIG. 8 is a software functional block diagram illustrating an example of software functionality of the touch panel. The software configuration of the touch panel 100 has a hierarchical structure including, for example, from the lowermost layer, a kernel layer, a HAL layer (hardware abstraction layer), a library layer, an application framework layer, and an application layer. The following functions may be implemented by causing the CPU 101 to execute the programs 130 so that the executed programs 130 cooperate with hardware resources of the touch panel 100.

The kernel layer is configured to implement an OS basic function such as a device driver. The kernel layer includes a data transfer driver 23. The data transfer driver 23 is configured to control the I/F 11s to perform data transfer or perform communications with an adjacent touch panel 100. Note that examples of the OS include Linux (registered trademark), Unix (registered trademark), Android (registered trademark), IOS (registered trademark), and Windows (registered trademark).

The HAL layer is a program configured to absorb the difference between hardware platforms. In this embodiment, the HAL layer is configured to bridge a gap (difference) between the library layer and the kernel layer. The library layer is configured to incorporate a library that controls hardware.

The application framework layer is configured to implement subordinate processes of the applications, and includes an object resource manager 21 and a screen display manager 22. The object resource manager 21 is configured to manage a position of the object 14 (an operation target) on the screen, and update data in the data storage part 29.

The application layer is configured to implement applications. For example, the application layer is configured to display a menu or receive settings for operating the touch panel 100.

The object resource manager 21 includes an object selection receiver 24 configured to receive selection of the object 14, a moving vector calculator 25 configured to calculate a moving vector (position, moving velocity, moving direction) of the object 14, a transfer determiner 26 configured to determine to transfer the calculated vector when the moving velocity is greater than or equal to a threshold, and a transfer destination determiner 27 configured to determine a touch panel serving as a transfer destination of the object 14 based on the position and the moving direction of the object 14. The screen display manager 22 is configured to manage a screen display of the object 14 serving as the operation target.

The object resource manager 21 is configured to report to the data transfer driver 23 the transfer destination touch panel 100, the moving vector, and the object 14 subject to moving. Hence, the data transfer driver 23 is configured to transfer transmission data (described later) in a predetermined format.

The data transfer driver 23 of the transfer destination touch panel 100 receives the transferred transmission data when the data transfer driver 23 determines that the transferred transmission data is addressed to itself (the touch panel 100 itself) by referring to a transmission destination of the transferred transmission data.

Note that the data storage part 29 stores drawn data such as strokes or images. The data storage part 29 is held in each of the touch panels 100. When the object 14 is moved, data of the object 14 in the data storage part 29 of the touch panel 1-1 are stored in the data storage part 29 of the moving destination touch panel 1-2.

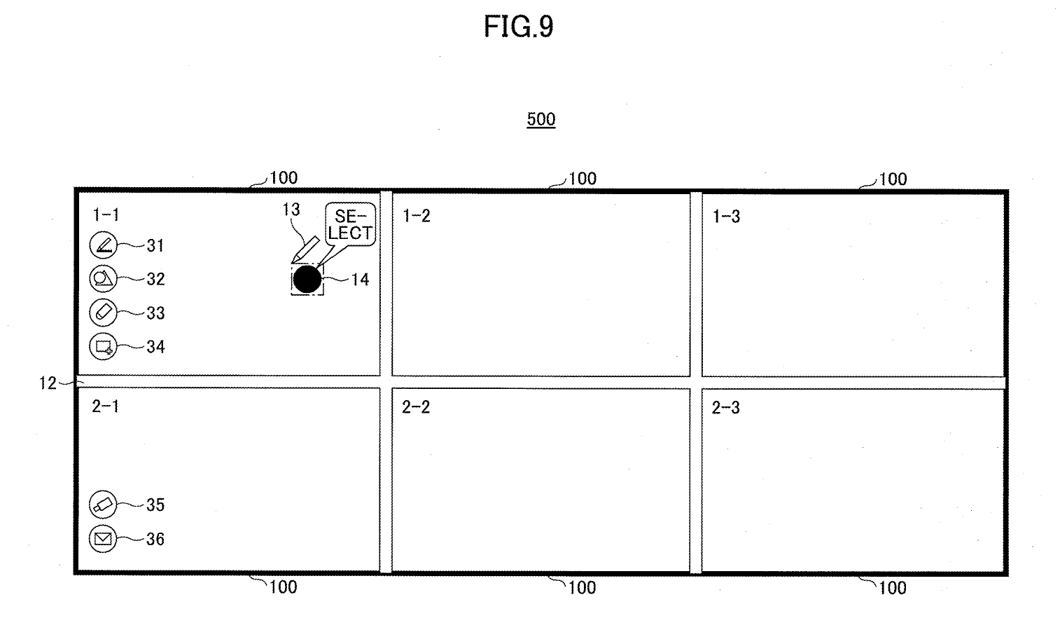

FIG. 9 is a diagram illustrating an example of a menu screen displayed by an application layer. The applications installed in each of the touch panels 100 display a screen corresponding to its disposed position. For example, the touch panels 1-1 and 2-1 display respective operations menus. Each of the menus includes icons. The upper left touch panel 1-1 displays a pen icon 31, a graphic icon 32, a selection/deletion icon 33, and a new page icon 34 as predetermined icons at predetermined positions. Likewise, the lower left touch panel 2-1 displays a USB memory icon 35, and a mail storage icon 36 as predetermined icons at predetermined positions.

Note that the user may be able to display the menu at any desired positions on surfaces of the touch panels. Further, the user may be able to switch ON/OFF the display of the menu.

The pen icon 31 is used by a user to input strokes with a PD (an electronic pen 13 in FIG. 9). When the user selects the pen icon 31, the user may further select the color or line width of the strokes.

The graphic icon 32 is used by the user to display a predetermined standard graphic or shape (a triangle, a circle, a square, etc.). When the user selects the graphic icon 32, the user may further select the color or line width of the graphic. In FIG. 9, a circle (an object) is drawn with the graphic icon 32.

The selection/deletion icon 33 is used by the user to select the drawn strokes. When the user presses the selection/deletion icon 33 and moves the PD to enclose the strokes or graphics, the strokes and graphics within the selected area are selected. The selected strokes and graphics may be enclosed with a circumscribed rectangle or displayed with highlight such that the user acknowledges that the strokes and graphics enclosed with a circumscribed rectangle or displayed with highlight have been selected. The object selection receiver 24 is configured to receive the selection of the object 14 such as the selected strokes or a circle. In this embodiment, the selected object 14 serves in a moving target. Note that the strokes or graphics may be selected by allowing the user or PD to touch the strokes or graphics for a predetermined time or more other than by allowing the user or PD to enclose the strokes or graphics.

The new page icon 34 is used by the user to open a new page. The strokes and graphics already drawn are stored. That is, the strokes or graphics already drawn on the six touch panels 100 are stored in the touch panels 100 that display the strokes and graphics, respectively. Data corresponding to one screen stored in each of the touch panels 100 is called “a page”. Note that the touch panel 100 that is specified by the user or that has received the operation of the new page icon 34 may store the strokes or graphics.

The USB memory icon 35 is used by the user to store all the saved pages in a PDF file.

The mail storage icon 36 is used by the user to transmit all the saved pages in a PDF file.

Note that when the user selects an icon of a certain touch panel 100, selection information of the selected icon may be shared with other touch panels 100. For example, after the user presses the pen icon 31 on the touch panel 1-1, the touch panel 100 that has detected the icon transmits the touched icon (information) to all the other touch panels 1-2, 1-3, 2-1, 2-2, and 2-3 such that the user may be able to draw strokes on the touch panels other than the touch panel 1-1. Hence, even though the user starts drawing strokes or the like on any of the touch panels 100, the touch panel 100 on which the strokes or the like are drawn may display the drawn content according to the icon selected by the user. Further, when the user presses the new page icon 34, the touch panels 100 may be able to simultaneously store the page to switch the page into the new page.

### Data Example

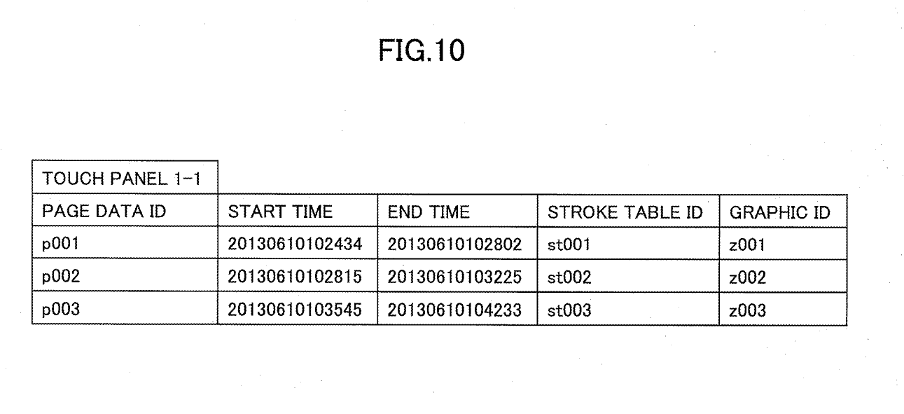

Next, an illustration is given of page data stored in the data storage part 29 with reference to FIGS. 10 to 13B. FIG. 10 is a schematic diagram illustrating an example of page data. One set of the page data corresponds to data of one page displayed on one of the touch panels 100. Each set of the page data includes a page data ID for identifying the page, a start time indicating a time at which the page is displayed, an end time indicating a time at which the content such as the strokes or graphics of the page is not rewritten any longer, a stroke table ID for identifying stroke table data generated by the electronic pen or the user's hand, and a graphic ID for identifying graphic data that are stored in association with one another. The graphic data are those displayed on the touch panels 100. The graphic data represent an example of shape information in the claims.

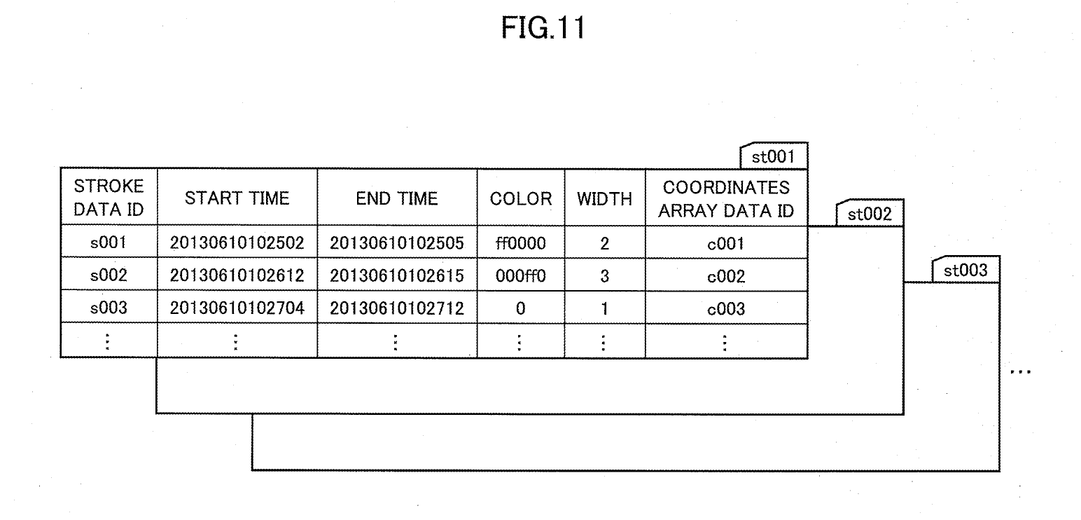

FIG. 11 is a schematic diagram illustrating an example of stroke table data. One of the stroke table data is a set of plural stroke data. Each of the stroke data includes a stroke data ID for identifying stroke data, a start time indicating a time to start writing one stroke, an end time indicating a time to end writing the stroke, the color of the stroke, the width of the stroke, a coordinates array data ID for identifying coordinates array of passing points of the stroke.

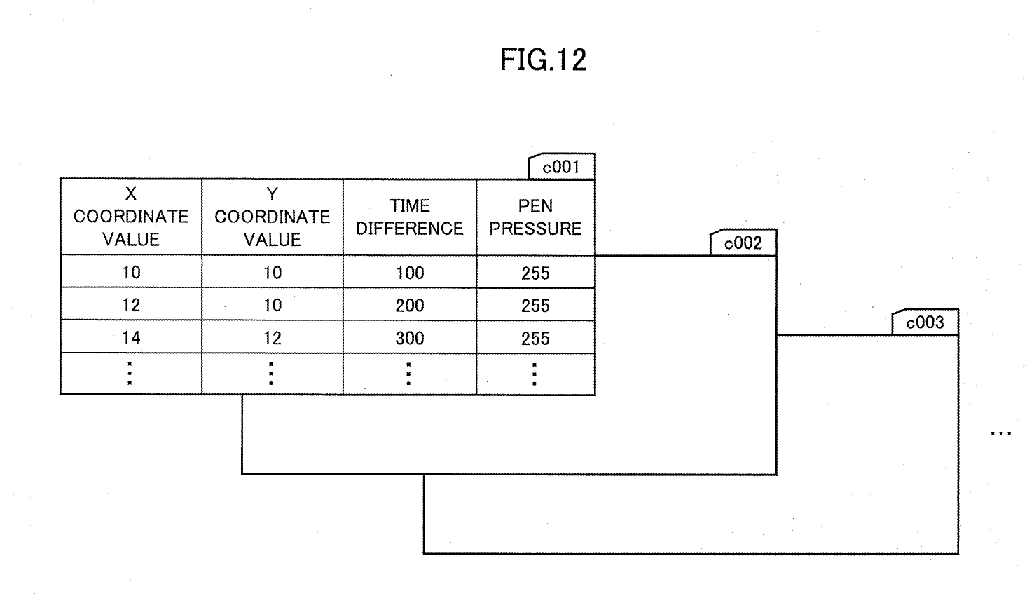

FIG. 12 is a schematic diagram illustrating an example of coordinates array data. The coordinates array data includes various types of information including an X coordinate value and a Y coordinate value of a point on the touch panel 100, the time difference (ms) from the start time of the stroke that has passed this point, and a pen pressure of the electronic pen at this point. A set of the points illustrated in FIG. 12 is represented by one coordinates array data illustrated in FIG. 11. For example, to draw the alphabet “S”, plural passing points have been passed until drawing (reaching) the end of the “S”. Hence, the coordinates array data is a set of the coordinates of the plural passing points.

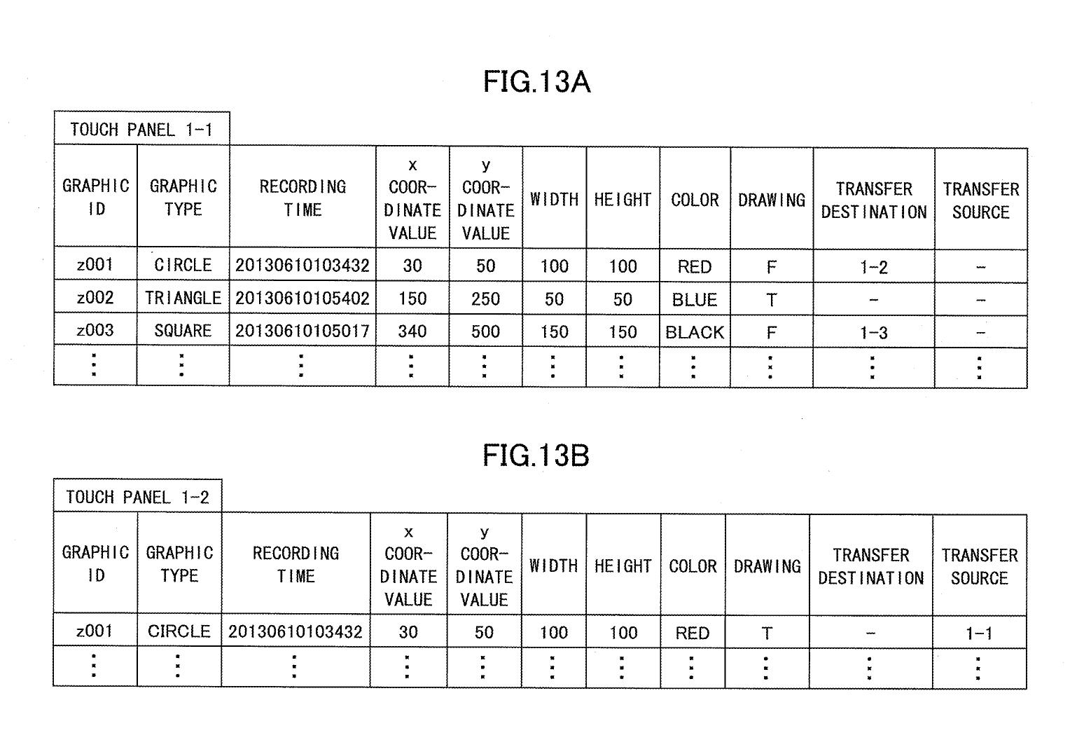

FIGS. 13A and 13B are schematic diagrams illustrating an example of graphic data. The graphic data includes a graphic ID, a graphic type, a recording time, an X coordinate value, a Y coordinate value, the width, the height, the color, drawing, a transfer destination, and a transfer source that are associated with the touch panels 100. The graphic type indicates a type of a graphic or shape such as a circle, a triangle, and a square. The recording time indicates a time to record the graphic. The “X coordinate value” and the “Y coordinate value” indicate the vertex (e.g., upper left vertex) of the circumscribed rectangle at the position where the shape is displayed. The “width” and the “height” indicate the size of the circumscribed rectangle. The “color” indicates color information of the graphic. The “drawing” indicates the presence or absence of the drawing, where T indicates the presence of the drawing, and F indicates the absence of the drawing. Further, the “transfer destination” is registered when the object 14 is transferred to that transfer destination. The “transfer source” indicates at least an immediately preceding transfer source; however, the “transfer source” may include all the preceding transfer sources.

When the later described transmission data are transferred to the transfer destination touch panel 100, the I/F number of the transfer destination touch panel 100 is registered in the “transfer destination”. Subsequently, when the transfer destination touch panel 100 ends drawing the object 14, F is registered in the “drawing”. Hence, the “drawing” and the “transfer destination” may be interlocked; however, the “drawing” and the “transfer destination” are not necessarily updated simultaneously.

FIG. 13A illustrated an example of graphic data of the touch panel 1-1, and FIG. 13B illustrated an example of graphic data of the touch panel 1-2. As illustrated in FIG. 13A, a graphic having the “graphic ID” “z001” has the “transfer destination” “1-2” and the “drawing” “F”. This indicates that the graphic is to be transferred to the touch panel 1-2, and the drawing is not present (i.e., the graphic is yet to be drawn). As illustrated in FIG. 13B, a graphic having the “graphic ID” “z001” has the “transfer source” “1-1” and the “drawing” “T”. This indicates that the graphic is transferred from the touch panel 1-1, and the drawing is present (i.e., the graphic has already been drawn).

Note that in light of moving the graphic data, it may be preferable to record coordinates array data while the graphic is moving in a manner similar to the stroke case. Since the coordinates of the moved graphic may be reproduced by recording the coordinates array data while the graphic is moving, the graphic data may be displayed at the coordinates at which the graphic has passed while moving.

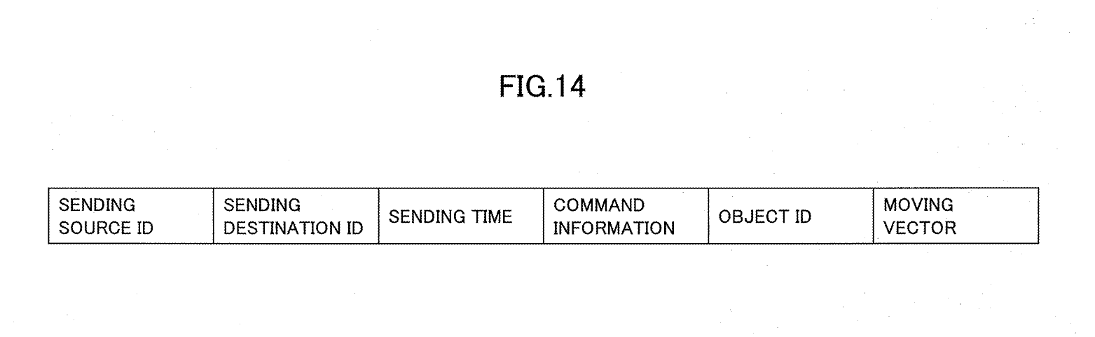

FIG. 14 is a diagram illustrating an example of transmission data transmitted by a touch panel 100 configured to report movement of an object to a moving destination touch panel 100. The transmission data may, for example, include respective fields of a “transmission source ID”, a “transmission destination ID”, a “transmission time”, “command information”, an “object ID”, and a “moving vector”. The transmission source ID indicates an I/F number such as 1-1, 1-2, and the like. The transmission destination ID indicates an I/F number such as 1-1, 1-2, and the like. All the I/F numbers may be specified as the transmission destination ID. The command information stores contents of reports. In this embodiment, a transfer request of the object 14 is stored as a command. Identifier information of an icon selected by the user may be stored according to the user's operation. In addition, other requests, commands, and responses communicated between the touch panels 100 may be stored. The object ID stores identifier information to identify the object 14 subject to moving. When a graphic is subject to moving, the graphic ID is stored as the object ID. When a stroke is subject to moving, the stroke data ID is stored as the object ID. Note that plural graphic IDs or plural strokes are selected via the selection/deletion icon 33, and the plural graphic IDs or plural stroke data IDs are stored as the object ID. The moving vector includes the current coordinates, moving velocity, and moving direction of the object 14. The calculation of the moving vector will be described later.

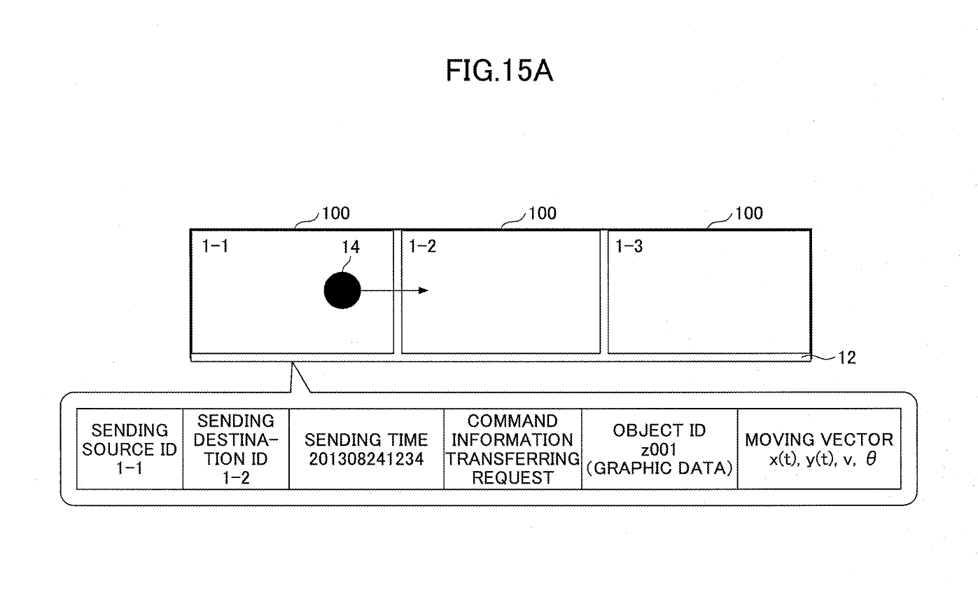

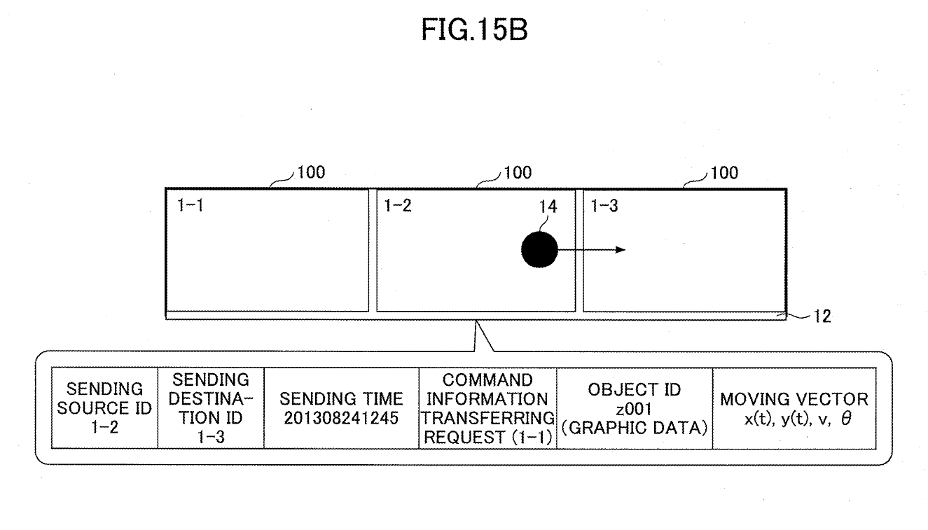

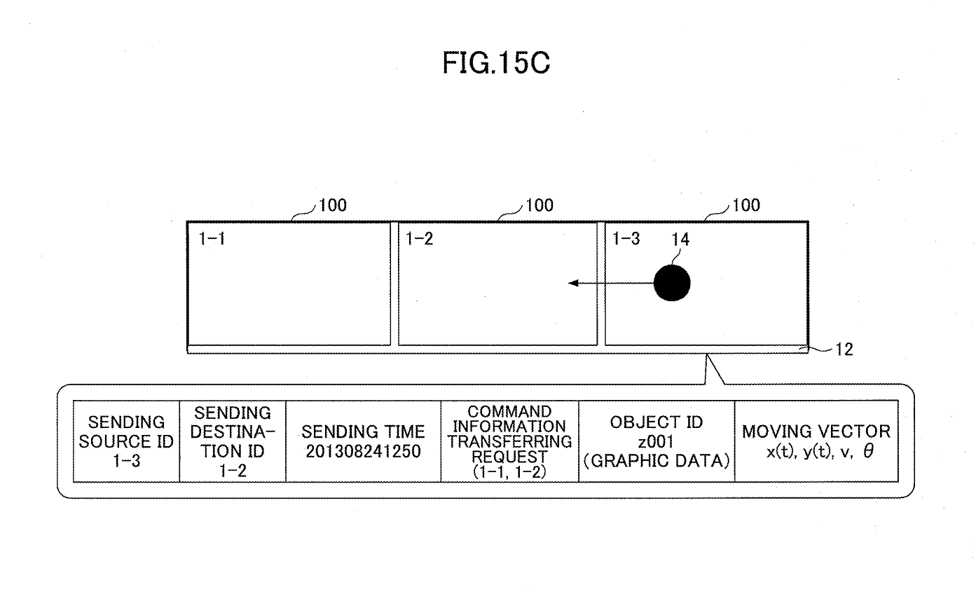

FIG. 15A is a diagram illustrating an example of the object 14 transfer corresponding to command information. The transmission data are transmitted from the touch panel 1-1 to the touch panel 1-2 at the transmission time “201308241234”. The command information indicates a transfer request. The object ID includes a graphic ID of z001; however, graphic data specified by the graphic ID are transferred together with the object ID. The moving vector includes the coordinates represented by x(t), and y(t), the moving velocity represented by v, and the moving direction represented by θ.

FIG. 15B is a diagram illustrating an example of the transmission data when the object 14 is moved from the touch panel 1-2 to the touch panel 1-3. The touch panel 1-2 adds a transfer source I/F (an example of transmission source information in the claims) to the command information when to further transfer the transferred object 14. Hence, the touch panel 1-3 may be able to determine which touch panel has initially created the object 14 that is transferred from the touch panel 1-2 (i.e., the touch panel 1-1 in this case).

FIG. 15C is a diagram illustrating an example of the transmission data when the object 14 is moved from the touch panel 1-2 to the touch panel 1-3. Likewise, the touch panel 1-3 adds a transfer source I/F number to the command information when the transferred object 14 is to be further transferred. Hence, the touch panel 1-2 may be able to determine not only which touch panel 100 has initially created the object 14 transferred from the touch panel 1-3, but also determine all the touch panels 100 on which object 14 has been present or displayed (the object 14 has passed).

The user may be able to display the object 14 again on any of the touch panels 100 that the object 14 has passed by recording a history of all the touch panels 100 that the object 14 has passed. For example, when a predetermined icon (e.g., an icon by which an immediately preceding touch panel 100 is displayed every time the user presses the icon once) is prepared, the object 14 is displayed sequentially on the touch panels 1-2, 1-3, 1-2, 1-1 in this order every time the user presses the predetermined icon once. Thus, the user may be able to display the object 14 again on a desired one of the touch panels 100.

In addition, since the transmission data includes information about which touch panel 100 has initially created the transferred object 14, the object 14 may be displayed on the touch panel 100 that has initially created the object 14 by pressing and holding the predetermined icon down.

### Calculation of Moving Vector

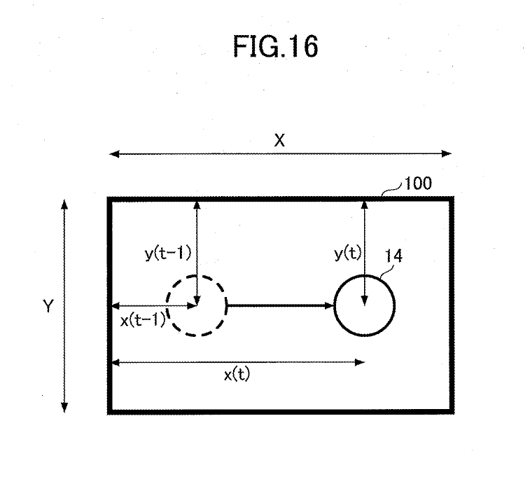

FIG. 16 is a diagram illustrating an example of moving vectors. This example illustrates the moving vectors of a graphic.

A broken line circle indicates an object 14 at sampling time t−1 of the coordinates of the touch panel 100. At sampling time t−1, the coordinates of the object 14 are x(t−1), y(t−1).

A solid line circle indicates the object 14 at sampling time t of the coordinates of the touch panel 100. At sampling time t, the coordinates of the object 14 are x(t), y(t).

Since the object resource manager 21 detects coordinates of the object 14 for every sampling period, the moving vector calculator 43 calculates the moving velocity v at a sampling time t as follows.

Moving velocity v=√[{x(t)−x(t−1)}²+{y(t)−y(t−1)}²]/sampling period

Further, the moving direction is obtained by a moving distance in an x direction and a moving distance in a y direction. For example, the moving direction is represented by θ based on a horizontal direction as illustrated below.

The moving direction θ=arctan {y(t)−y(t−1)/x(t)−x(t−1)}

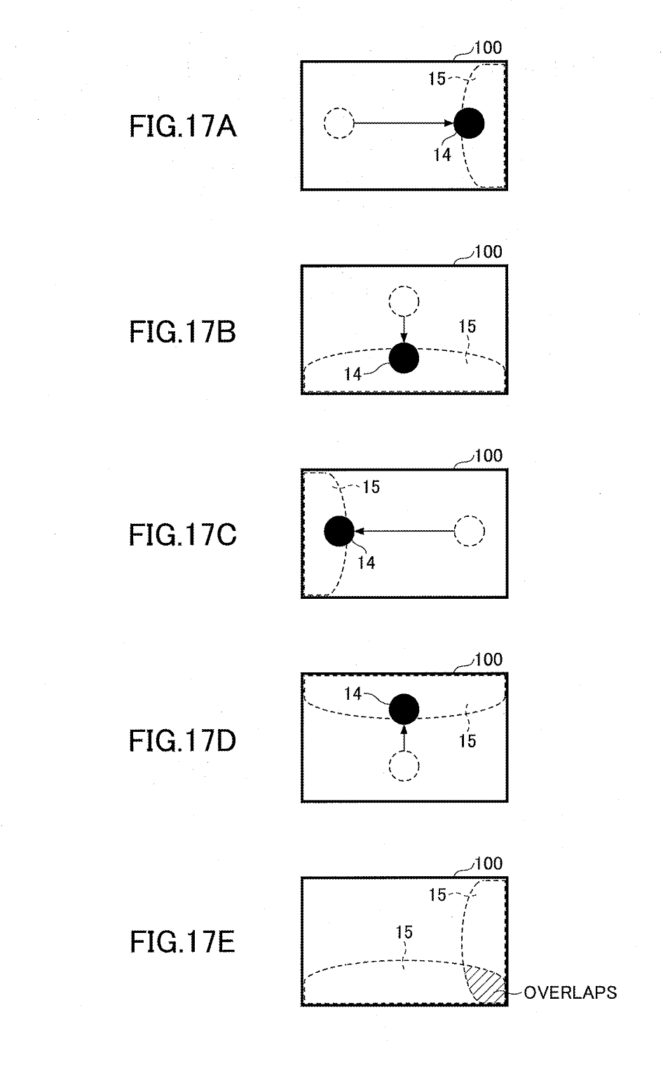

FIGS. 17A to 17E are diagrams illustrating examples of a transfer triggering area 15. Each transfer triggering area 15 represents an area of the display 200 used for determining whether to transfer the object 14 when the object 14 is present in the corresponding area. By defining such transfer triggering areas 15, it is not necessary to determine whether to transfer the object 14 in all the areas of the display 200. This may result in the reduction in workload. Further, since a transfer triggering area 15 may be set at each of four sides of the touch panel 100, it is possible to determine whether to transfer the object 14 by restricting the transfer destinations.

FIG. 17A is a diagram illustrating an example of the transfer triggering area 15 that is used for determining whether to transfer the object 14 to the right side touch panel 100. The transfer triggering area 15 has a rectangular parallelepiped shape having a slightly wider middle part. The shape of the transfer triggering area 15 is only one example, and may be optionally designed. When the object 14 is present in the transfer triggering area 15 of FIG. 17A, the transfer destination determiner 27 determines whether to transfer the object 14 to the adjacent touch panel 100 on the right side.

FIG. 17B is a diagram illustrating an example of a transfer triggering area 15 that is used for determining whether to transfer the object 14 to the lower side touch panel 100. When the object 14 is present in the transfer triggering area 15 of FIG. 17B, the transfer destination determiner 27 determines whether to transfer the object 14 to the adjacent touch panel 100 on the lower side.

FIG. 17C is a diagram illustrating an example of the transfer triggering area 15 that is used for determining whether to transfer the object 14 to the left side touch panel 100. When the object 14 is present in the transfer triggering area 15 of FIG. 17C, the transfer destination determiner 27 determines whether to transfer the object 14 to the adjacent touch panel 100 on the left side.

FIG. 17D is a diagram illustrating an example of the transfer triggering area 15 that is used for determining whether to transfer the object 14 to the upper side touch panel 100. When the object 14 is present in the transfer triggering area 15 of FIG. 17D, the transfer destination determiner 27 determines whether to transfer the object 14 to the adjacent touch panel 100 on the upper side.

FIG. 17E is a diagram illustrating an example of an overlapped area of the transfer triggering areas 15. In some shapes of the transfer triggering areas 15, the two transfer triggering areas 15 may overlap at four corners of the display 200. In such a case, the transfer destination determiner 27 determines whether to transfer the object 14 to the touch panels 100 having respective sides adjacent to the transfer triggering areas 15. That is, the transfer destination determiner 27 may determine whether to transfer the object 14 to the adjacent touch panel 100 twice. Alternatively, the transfer triggering areas 15 may be designed such that the transfer triggering areas 15 form no overlapped area.

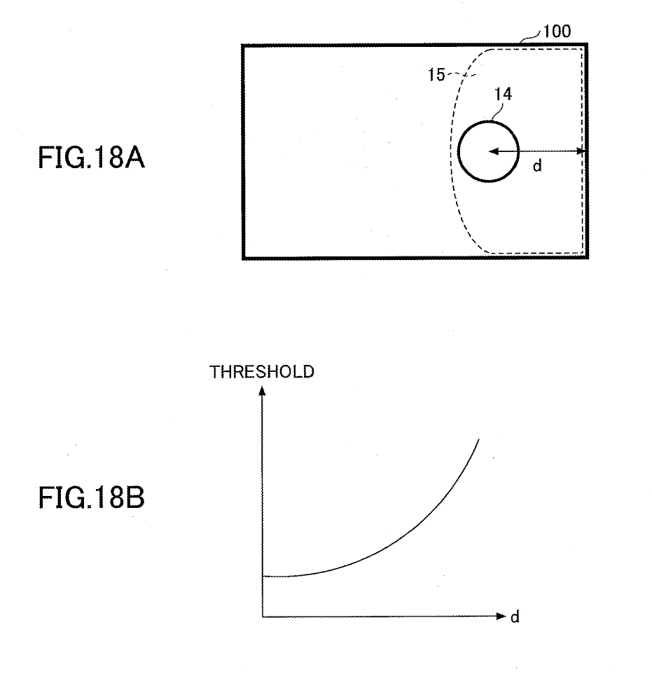

FIGS. 18A and 18B are diagrams illustrating an example of a relationship between a position and a threshold of the object 14 within the transfer triggering area 15. FIG. 18A schematically illustrates a distance d between a side corresponding to the transfer triggering area 15 and the object 14. The threshold may vary with the distance d. Specifically, the less the distance d is, the less the threshold may be.

FIG. 18B is a diagram illustrating a relationship between the distance d and the threshold. The less the distance d is, the less the threshold has become. Further, when the distance d is increased, the threshold is sharply increased. In this configuration, the object 14 close to the middle part of the display 200 will not be transferred unless the moving velocity of the object 14 is high. Thus, transferring of the object 14 unintended by the user may be controlled. Further, the object 14 displayed close to the end of the display 200 may be transferred at a lower moving velocity. However, unintended transferring of the object 14 may be controlled by setting the threshold.

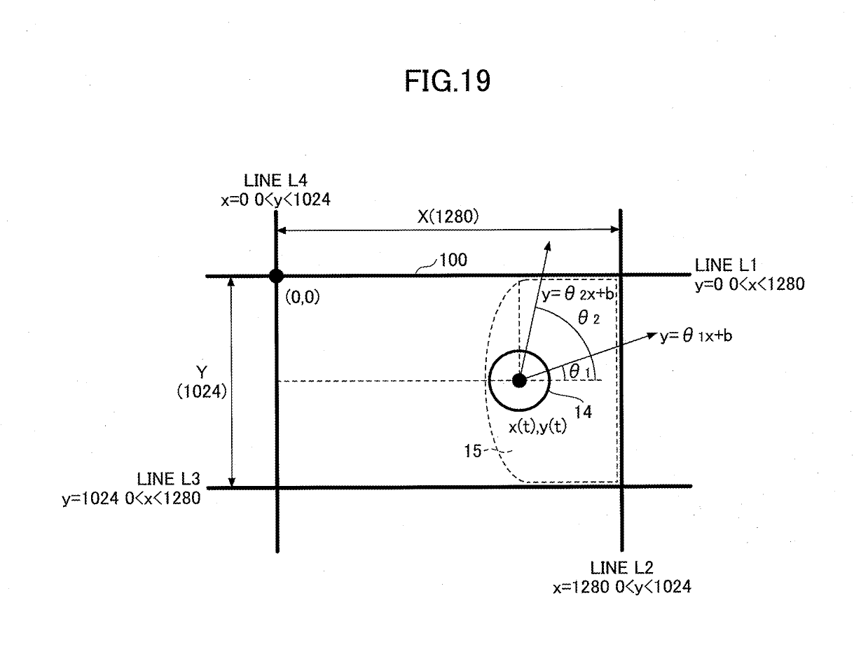

FIG. 19 is a diagram illustrating an example of determination of a transfer destination touch panel 100. Since the coordinates x(t), y(t), and the moving direction θ are obtained by calculating the moving vector, the transfer destination determiner 27 creates moving lines having respective slopes θ (an example of an extending line in the claims) that have passed the coordinates x(t), y(t). In this example of FIG. 19, two moving lines are presented.

The moving line 1:y=θ1*x+b

The moving line 2:y=θ2*x+b

Further, four sides (i.e., upper side, right side, lower side, and left side) of the touch panel 100 may be represented by the following formulas.

The upper side line L1:y=0 0<x<1280

The right side line L2:x=1280 0<y<1024

The lower side line L3:y=1024 0<x<1280

The left side line L4:x=0 0<y<1024

The transfer destination touch panel 100 is determined based on the transfer triggering area 15 in which the object 14 is currently displayed. However, whether the displayed object 14 is actually transferred to the touch panel 100 corresponding to the transfer triggering area 15 may be determined based on whether the moving lines intersect the sides of the touch panel 100 corresponding to the transfer triggering area 15.

For example, since the moving line 1 intersects a side of the touch panel 100 corresponding to the transfer triggering area 15, the transfer destination determiner 27 determines to transfer the object 14 to the adjacent touch panel 100 on the right side. However, the moving line 2 does not intersect the side of the touch panel 100 corresponding to the transfer triggering area 15, and hence, the transfer destination determiner 27 does not determine to transfer the object 14 to the adjacent touch panel 100 on the right side.

Similarly, in a case of the object 14 being in the transfer triggering area 15 in FIG. 17A, the transfer destination determiner 27 determines whether the moving line intersects the line L2. In a case of the object 14 being in the transfer triggering area 15 in FIG. 17B, the transfer destination determiner 27 determines whether the moving line intersects the line L3. In a case of the object 14 residing in the transfer triggering area 15 in FIG. 17C, the transfer destination determiner 27 determines whether the moving line intersects the line L4. In a case of the object 14 residing in the transfer triggering area 15 in FIG. 17D, the transfer destination determiner 27 determines whether the moving line intersects the line L1.

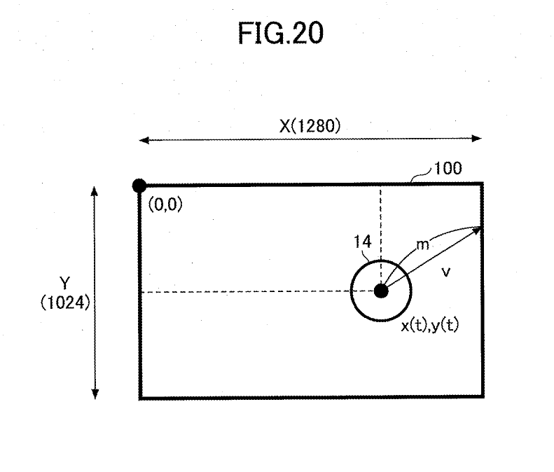

FIG. 20 is a diagram illustrating an example of determination of display timing of the object 14 made by the transfer destination touch panel 100. The transfer destination touch panel 100 acquires the coordinates x(t), y(t), the moving velocity v, and the moving direction θ based on the transmission data.

Further, the distance between the object 14 and the end of the transfer source touch panel 100 may be obtained based on the coordinates x(t), y(t), and the size of the display 200 as noted below. Note that the number of pixels of the display 200 may be the same in all the touch panels 100, or may be obtained from one another via communications.

Distance m=√{(1280−x(t))²+(1024−y(t))²}

The time T at which the displayed object 14 reaches the end of the transfer destination touch panel 100 may be obtained as noted below.

Time T=Distance m/Moving velocity v

Further, since the transmission data include a transmission time, the screen display manager 22 displays the object 14 at the transmission time+the time T. Note that since the moving velocity v is gradually decreased in practice, it is preferable to determine the moving velocity v to be the mean of the moving velocities obtained until the object 14 reaches the end of the touch panel 100, or the moving velocity to be a value corrected by including deceleration.

Moreover, the display position of the object 14 may be specified by the intersection point of the moving line and a side (corresponding to the line L2) acquired by the object resource manager 21 of the transfer destination touch panel 100 based on the moving vector.

### Operation Process

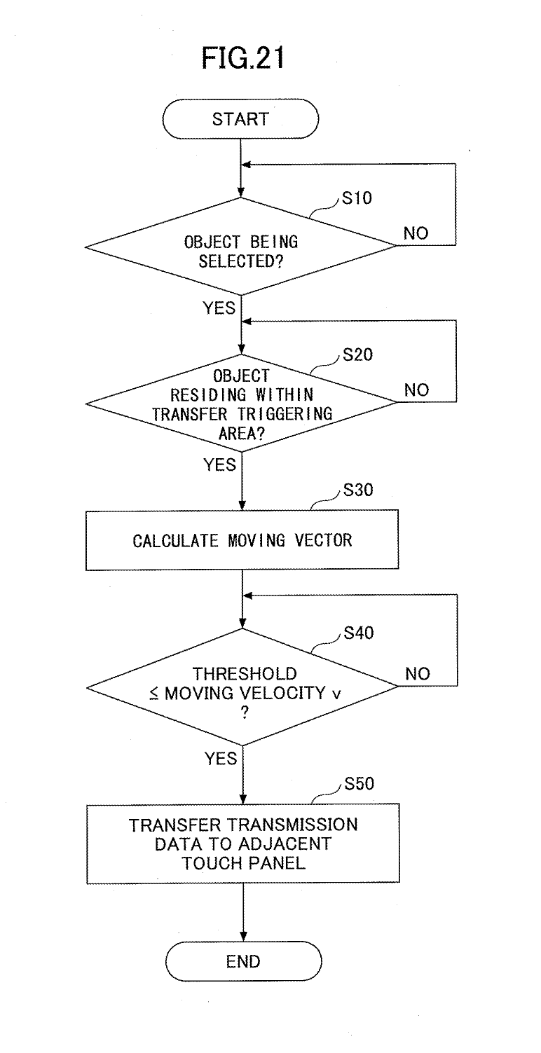

FIG. 21 is a flowchart illustrating an example of a process in which the object resource manager 21 determines whether to transfer the object 14.

Initially, the object selection receiver 24 determines whether the object 14 is being selected (step S10). That is, whether there is the object 14 that the user selects by using the selection/deletion icon 33 is determined. The unselected object 14 will not be transferred. The user may be able to move the object 14 by dragging (moving while in contact with the object 14) or swiping while the object 14 is being selected.

When the object 14 is selected (YES in step S10), the transfer determiner 26 determines whether the position of the object 14 resides within the transfer triggering area 15 (step S20).

When the position of the object 14 resides within the transfer triggering area 15 (YES in step S20), the moving vector calculator 25 calculates the moving vector of the object 14 (step S30). That is, the moving vector calculator 25 calculates the coordinates, the moving velocity v, and the moving direction θ.

The transfer determiner 26 determines whether the moving velocity v is greater than or equal to the threshold (step S40). That is, the transfer determiner 26 calculates the distance d from the object 14 to the corresponding side, determines a threshold based on the distance d, and compares the moving velocity v with the determined threshold. The transfer destination determiner 27 determines whether the moving line obtained based on the moving vector intersects the side corresponding to the transfer triggering area 15 (i.e., whether the moving direction is directed at the corresponding side).

When the moving velocity v is greater than or equal to the threshold (YES in step S40), the object resource manager 21 requests the data transfer driver 23 to transmit the transmission data, and the data transfer driver 23 transmits the transmission data to the transfer destination touch panel 100 (step S50).

Thereafter, the screen display manager 22 of the transfer source touch panel 100 stops displaying the object 14 when the displayed object 14 has reached the end of the transfer source touch panel 100. Further, the screen display manager 22 of the transfer destination touch panel 100 starts displaying the object 14 when the time T at which the displayed object 14 reaches the end of the transfer source touch panel 100 has elapsed.

As described above, the transmission destination touch panel 100 may be able to receive the transmission data of the object 14 in advance by causing the transfer source touch panel 100 to transmit the transmission data of the object 14 while the transfer source touch panel 100 still displays the object 14. The transfer destination touch panel 100 may be able to prepare to display the object such as to estimate a display position of the object 14. Hence, the transfer destination touch panel 100 may be able to display the object 14 smoothly without delay or interruption (at the timing at which the displayed object 14 has reached the end of the transfer source touch panel 100).

Configuration Example of Panel System Other than Touch Panels

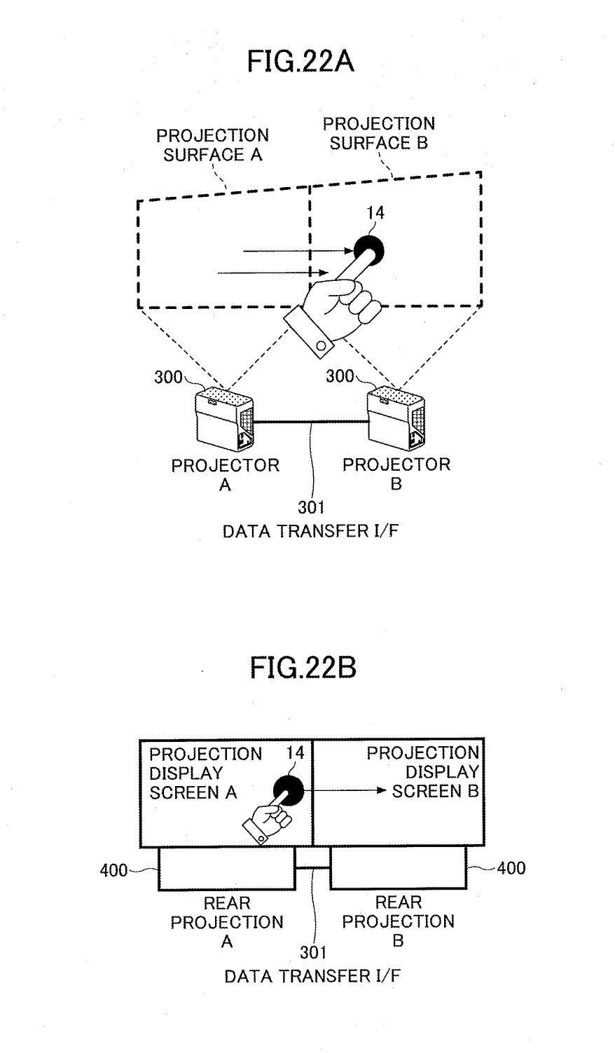

FIG. 22A is a diagram illustrating a configuration example of a panel system 500 composed of two projectors 300. The projectors A and B are connected via a data transfer I/F 301. Hence, the projector A may be able to transfer transmission data to the projector B, and the projector B may be able to transfer transmission data to the projector A.

A projection surface A of the projector A and a projection surface B of the projector B are linearly aligned in parallel as illustrated in FIG. 22A. The coordinates of the PD in each of the projection surfaces A and B may be calculated, for example, by infrared radiation shielding triangulation. Alternatively, the coordinates of the user's finger or the PD in each of the projection surfaces A and B may be obtained by imaging the user's finger or the PD with a camera.

The coordinates of the PD detected in the projection surface A is input into the projector A, and the coordinates of the PD detected in the projection surface B is input into the projector B. Hence, the projector A detects the coordinates of the PD in the projection surface A, and the projector B detects the coordinates of the PD in the projection surface B. Alternatively, the coordinates of the PD may be detected regardless of the projection surfaces A and B, and the detected coordinates of the PD may be input into either of the projectors A and B. The projectors A and B are capable of determining whether the position of the PD corresponds to their respective projection surfaces based on the detected coordinates.

Hence, even though the panel system 500 is composed of plural projectors 300, the projector A, for example, detects that the object 14 is selected based on the detected coordinates of the PD, and moves the object 14. Accordingly, the object 14 may be able to move from the projection surface A to the projection surface B in a manner similar to the panel system composed of the touch panels 100.

FIG. 22B is a diagram illustrating a configuration example of a panel system 500 composed of two rear projections 400. The rear projections A and B are connected via a data transfer I/F 301. Hence, the rear projection A may be able to transfer transmission data to the rear projection B, and the rear projection B may be able to transfer transmission data to the rear projection A.

A projection display surface A of the rear projection A and a projection display surface B of the rear projection B are linearly aligned in parallel as illustrated in FIG. 22B. The coordinates of the PD in this case may be obtained by the infrared radiation shielding triangulation, or by imaging the PD or the user's finger from the rear surfaces (inside projection display surfaces).

Accordingly, even though the panel system 500 is composed of plural rear projections 400, the object 14 may be able to move from the projection display surface A to the projection display surface B in a manner similar to the panel system composed of the touch panels 100.

### Second Embodiment

In the first embodiment, the transfer destination touch panel 100 displays the object 14 by simply causing the transfer source touch panel 100 to transmit the transmission data to the transfer destination touch panel 100.

However, there is a case where the user wishes to stop transferring the object 14 after the transfer source touch panel 100 has just transferred the object 14. Further, when the transfer source touch panel 100 draws the object 14 and the transfer destination touch panel 100 starts displaying the object 14 independently of the transfer source touch panel 100, the timing to stop displaying the object 14 in the transfer source touch panel 100 may fail to match the timing to draw (display) the object 14 in the transfer destination touch panel 100.

Accordingly, in the panel system 500 according to the second embodiment, the transfer source touch panel 100 and the transfer destination touch panel 100 are caused to perform more precise communications such that the object 14 may be transferred more smoothly without delay or interruption.

Note that the panel system 500 according to the second embodiment includes a hardware configuration and a software configuration similar to those of the panel system 500 according to the first embodiment. Further, in the panel system 500 according to the second embodiment, components that are provided with the same reference numbers as those of the panel system 500 according to the first embodiment perform the same functions. Hence, only main components of the second embodiment may be described.

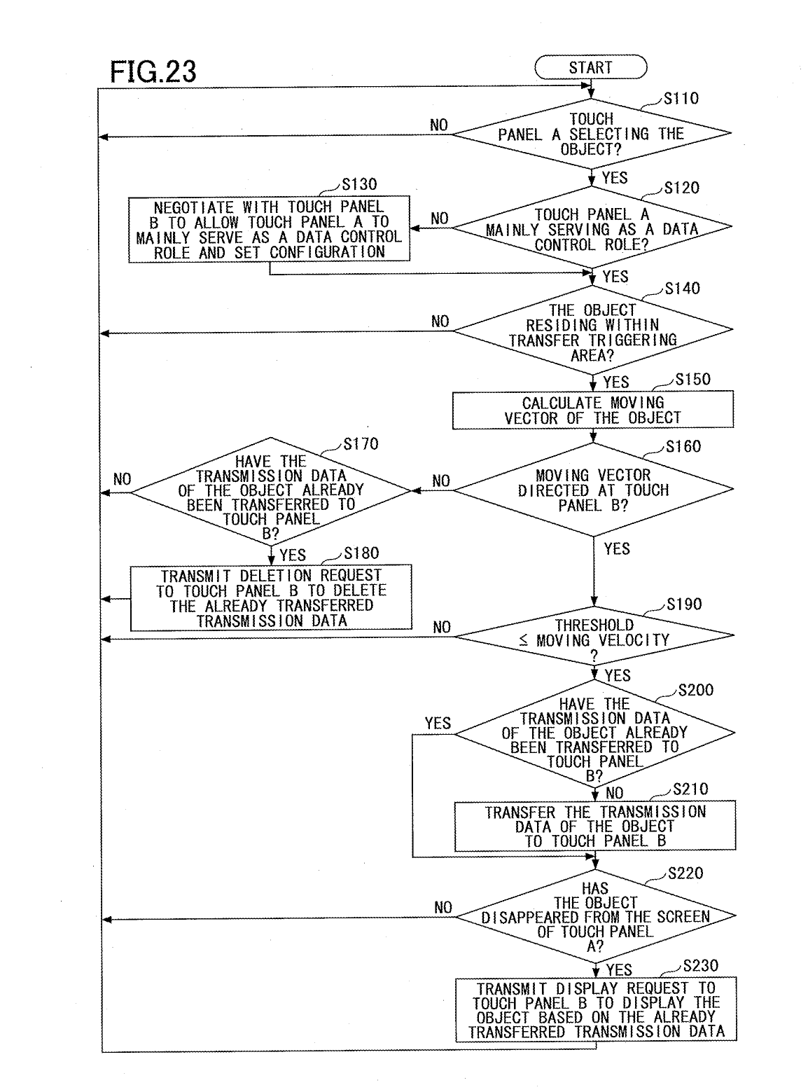

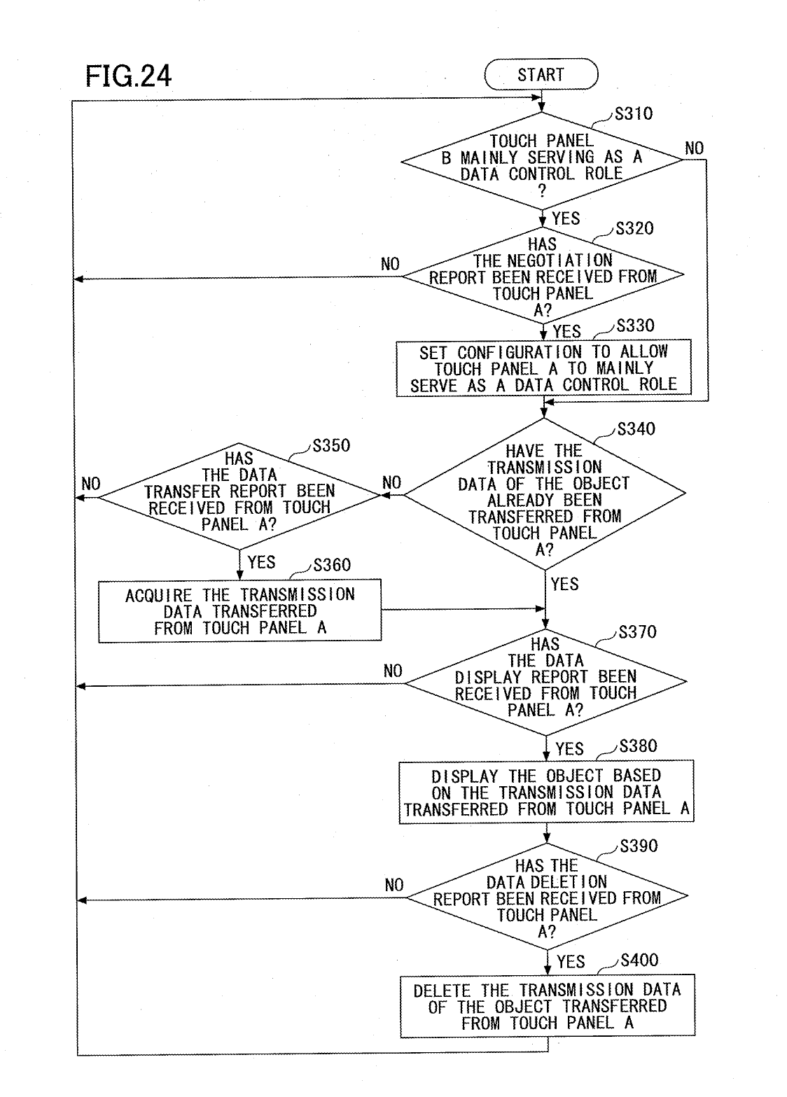

FIG. 23 is a flowchart illustrating an example of a process in which the transfer source touch panel 100 transfers the object 14, and FIG. 24 is a flowchart illustrating an example of a process in which the transfer destination touch panel 100 receives the transferred object 14. Note that in this example, the transfer source touch panel is provided with “A” and the transfer destination touch panel is provided with “B”.

The object selection receiver 24 determines whether the transfer source touch panel 100 is selecting the object 14 (step S110). When there is the object 14 that is being selected, the object selection receiver 24 reports to the data transfer driver 23 that there is a possibility of transferring the object 14.

When there is the object 14 that is being selected (YES in step S110), the data transfer driver 23 determines whether the touch panel A mainly serves in a data transfer role. For example, there is a restriction that the host-side apparatus mainly serves in a data transfer role in the host-device configuration based on the specification of the USB when the I/F 11 is a USB. When the touch panel A is assigned the device role, the touch panel A is unable to control transferring data to the touch panel B. Hence, it may be necessary to negotiate with the touch panel B in compliance with the On The Go (OTG) specification such that the touch panel A itself is assigned the host role. Further, when the I/F 11 is a PCI-Express, any one of the touch panels A and B may mainly serves in the data transfer role in the route-end point configuration. Hence, the determination step in step S120 is no longer necessary (i.e., forcibly proceed with step S140).

When the touch panel A does not mainly serves in the data transfer role (NO in step S120), the data transfer driver 23 negotiates with the touch panel B such that the touch panel A mainly serves in the data transfer role, and sets a configuration necessary for the data transfer role (step S130). For example, when the I/F 11 is a USB, the data transfer driver 23 (the touch panel A) executes protocols such as Session Request Protocol (SRP), and Host Negotiation Protocol (HNP) in compliance with the OTG specification such that the touch panel A itself serves in a host.

When the touch panel A mainly serves in the data transfer role, the transfer determiner 26 determines whether the position of the object 14 resides within the transfer triggering area 15 (step S140).

When the position of the object 14 resides within the transfer triggering area 15 (YES in step S140), the moving vector calculator 25 calculates the moving vector of the object 14 (step S150).

The transfer destination determiner 27 determines whether the moving direction θ of the moving vector is directed at the touch panel B (step S160). That is, the transfer destination determiner 27 determines whether the moving line computed based on the moving vector intersects a side adjacent to the touch panel B that is determined based on the transfer trigger area 15.

When the moving direction θ of the moving vector is not directed at the touch panel B (NO in step S160), the transfer destination determiner 27 determines whether the transmission data of the object 14 have already been transferred to the touch panel B by referring to the transfer destination of the object 14 in the graphic data (step S170). This determination is aimed at detecting that the transmission data of the object should not have been transferred due to the change in the direction of the object 14, despite the fact that the transmission data had been transferred because the transfer condition (e.g., the moving direction θ of the moving vector is directed at the touch panel B, and the moving velocity is greater than or equal to the threshold) is satisfied.

When the transmission data of the object 14 have already been transferred to the touch panel B (YES in step S170), the object resource manager 21 reports to the data transfer driver 23 that the data transfer driver 23 is to transmit a deletion request to the touch panel B to delete the already transferred transmission data (graphic data in this case) (step S180).

When the moving direction θ of the moving vector is directed at the touch panel B (YES in step S140), the transfer determiner 26 determines whether the moving velocity v of the moving vector is greater than or equal to the threshold (step S190).

When the moving velocity v is greater than or equal to the threshold (YES in step S190), the transfer destination determiner 27 determines whether the transmission data of the object 14 have already been transferred to the touch panel B by referring to the transfer destination of the object 14 in the graphic data (step S200). This determination is aimed at preventing the transmission data of the same object 14 from being transmitted again since retransmission is unnecessary.

When the transmission data of the object 14 have not been transferred yet (NO in step S200), the object resource manager 21 requests the data transfer driver 23 to transmit the transmission data, and the data transfer driver 23 transmits the transmission data to the transfer destination touch panel B (step S210).

Subsequently, the screen display manager 22 determines whether the displayed object 14 has been moved to the end of the display 200 of the touch panel A (i.e., the object 14 has disappeared due to being moved to outside the screen of the display 200 of the touch panel A) (step S220).

When the displayed object 14 has been moved to the end of the display 200 of the touch panel A (YES in step S220), the screen display manager 22 reports to the touch panel B via the data transfer driver that the object 14 is displayed on the display 200 based on the already transferred transmission data (step S230).

Subsequently, a process of the transfer destination touch panel B is illustrated with reference to FIG. 24.

Initially, the data transfer driver 23 of the touch panel B determines whether the touch panel B mainly serves in a data transfer role (step S310). This determination is aimed at receiving the negotiation from the touch panel A because the touch panel B does not need to mainly serves in the data transfer role.

When the touch panel B mainly serves a data transfer role (YES in step S310), the data transfer driver 23 of the touch panel B conducts polling to determine whether the negotiation report in step S130 is received from the touch panel A (step S320).

When the data transfer driver 23 of the touch panel B has received the negotiation report (YES in step S320), the data transfer driver 23 of the touch panel B negotiates with the touch panel A so as to allow the touch panel A to mainly serves in a data transfer role (step S330).

Subsequently, the transfer destination determiner 27 determines whether the transmission data of the object 14 transferred in step S210 has already been received from the touch panel A by referring to the transfer destination of the graphic data of the maintaining object 14 (step S340).

When the transmission data of the object 14 have not been transferred from the touch panel A yet (NO in step S340), the data transfer driver 23 determines whether the transmission data transfer report has been received from the touch panel A (step S350). That is, the data transfer driver 23 of the touch panel A and the data transfer driver 23 of the touch panel B in the same hierarchical level determine whether the transmission data have been received or transferred.

When the transmission data transfer report has been received from the touch panel A (YES in step S350), the data transfer driver 23 receives the transmission data from the touch panel A, and reports information about the received object 14 to the object resource manager 21 (step S360).

Subsequently, the data transfer driver 23 of the touch panel B conducts polling to determine whether the screen display report of the object 14 in step S230 has been received from the touch panel A (step S370).

When the screen display report of the object 14 has been received from the touch panel A (YES in step S370), the data transfer driver 23 reports receiving the screen display report from the touch panel A to the screen display manager 22, and causes the screen display manager 22 to display the object 14 on the display 200 based on the already transferred transmission data of the object 14 (step S380). Hence, since the touch panel B displays the object 14 when the screen display report of the object 14 has been received from the touch panel A, the touch panel B may be able to display the object 14 at a timing at which the touch panel A has stopped displaying the object 14.

Subsequently, the data transfer driver 23 conducts polling to determine whether a data deletion report of the object 14 in step S180 has been received from the touch panel A (step S390).

When the data deletion report of the object 14 has been received from the touch panel A (YES in step S390), the data transfer driver 23 reports the data deletion of the object 14 to the object resource manager 21, and the object resource manager 21 deletes the already transferred graphic data of the object 14 (step S400). That is, F may be set in the “drawing” of the graphic data, or the entire record itself may be deleted. Moreover, the screen display manager 22 stops displaying the object 14 on the display 200 any longer. Accordingly, even though the object 14 has once been displayed, the touch panel B terminates displaying the object 14 when the data deletion report is received from the touch panel A. This may prevent the object 14 from being displayed, the transmission data of which are yet to be transferred.

Accordingly, the panel system 500 according to the embodiments may be able to reliably determine whether the transfer source touch panel has transmitted the transmission data of the object 14, and transmit the transmission data to the transfer destination touch panel after the transfer source touch panel has transmitted the transmission data. That is, when the transmission data has been accidentally transferred, the transfer destination touch panel may be able to delete the accidentally transferred transmission data of the object 14. Further, the panel system 500 according to the embodiments may be able to display the object 14 on the transfer destination touch panel at a timing at which the transfer source touch panel has stopped displaying the object 14.

The embodiments may provide a panel system having plural displays aligned in an array that is capable of preventing a delay in displaying a drawing object across the plural displays.

The present invention is not limited to the specifically disclosed embodiments, and variations and modifications may be made without departing from the scope of the present invention.

The present application is based on Japanese Priority Application No. 2013-191152 filed on Sep. 13, 2013, the entire contents of which are hereby incorporated herein by reference.

What is claimed is:

1. A system comprising:
a plurality of information processing apparatuses each having a display device configured to display an image, at least two of the information processing apparatuses being capable of communicating with each other, wherein
a first information processing apparatus includes
a first display controller configured to control a first display device of the first information processing apparatus to display a display target;
a specified position detector configured to detect a position specified by a specifying operation with respect to a display surface of the first display device of the first information processing apparatus;
a receiver configured to receive movement of a display position of the display target displayed on the first display device of the first information processing apparatus based on the position detected by the specified position detector;
a movement information calculator configured to calculate movement information associated with the movement of the display position of the display target received by the receiver;
a determiner configured to determine whether to transmit display target information associated with the display target and the movement information of the display target to a second information processing apparatus based on the movement information calculated by the movement information calculator; and
a transmitter configured to transmit the display target information and the movement information of the display target to the second information processing apparatus when the determiner has determined to transmit the display target information and the movement information of the display target to the second information processing apparatus, and wherein
the second information processing apparatus includes
a second display controller configured to control a second display device of the second information processing apparatus to display the display target based on the display target information and the movement information of the display target transmitted by the transmitter.

2. The system as claimed in claim 1, wherein
the first display controller causes the first display device of the first information processing apparatus to stop displaying the display target at a timing at which the displayed display target has reached the second display device of the second information processing apparatus after the transmitter has transmitted the display target information and the movement information of the display target, and wherein
the second display controller causes the second display device of the second information processing apparatus to display the display target based on the display target information at the timing at which the displayed display target has reached the second display device of the second information processing apparatus based on the movement information.

3. The system as claimed in claim 1, wherein
the movement information includes a position, a moving direction, and a moving velocity of the display target.

4. The system as claimed in claim 3, wherein
the determiner determines to transmit the display target information and the movement information to the second information processing apparatus when the moving velocity is greater than or equal to a threshold.

5. The system as claimed in claim 3, wherein the first information processing apparatus further comprising:
a display device specifier configured to specify the second display device being present in the moving direction, wherein
when the display target is present in a determination area predetermined with respect to four sides of the first display device of the first information processing apparatus, the display device specifier determines whether a line extending toward the moving direction intersects one of the four sides with respect to the determination area, and wherein when the line extending toward the moving direction intersects one of the four sides with respect to the determination area, the display device specifier determines a display device adjacent to the side intersected by the line extending toward the moving direction as the second display device present in the moving direction.

6. The system as claimed in claim 3, wherein
the determiner calculates a distance from the display target to an end of the first display device of the first information processing apparatus based on the position and a size of the first display device of the first information processing apparatus, and
compares a threshold that is decreased as the distance is reduced and the moving velocity.

7. The system as claimed in claim 1, wherein
the first display controller transmits to the second display controller a non-display report indicating that the first display device of the first information processing apparatus has stopped displaying the display target, and
the second display controller causes, after having received the non-display report from the first display controller, the second display device to display the display target based on the display target information and the moving information transmitted by the transmitter.

8. The system as claimed in claim 5, wherein
after the transmitter has transmitted the display target information and the moving information of the display target, the moving information calculator recalculates the moving information,
the display device specifier determines whether the second display device of the second information processing apparatus to which the display target information and the moving information have been transmitted is present in the recalculated moving direction, and
when the second display device of the second information processing apparatus to which the display target information and the moving information have been transmitted is not present in the recalculated moving direction, the transmitter requests the second information processing apparatus to which the display target information and the moving information have been transmitted to stop displaying the display target.

9. The system as claimed in claim 5, wherein
when the second display controller receives from the transmitter a non-display request for causing the second display device of the second information processing apparatus to stop displaying the display target after the second display controller has caused the second display device of the second information processing apparatus to display the display target, the second display controller causes the second display device of the second information processing apparatus to stop displaying the display target.

10. The system as claimed in claim 1, wherein
when the second information processing apparatus transmits the display target information and the moving information of the display target received from the transmitter to a third information processing apparatus, the second information processing apparatus transmits identifier information of the first information processing apparatus as previous transmission source information together with information having the second information processing apparatus serving as a transmission source, and wherein
when the third information processing apparatus transmits the display target information and the moving information received from the second information processing apparatus to a fourth information processing apparatus, the third information processing apparatus transmits identifier information of the first information processing apparatus and identifier information of the second information processing apparatus as previous transmission source information together with information having the third information processing apparatus serving as a transmission source.

11. The system as claimed in claim 1, wherein
the plurality of the information processing apparatuses are a plurality of projectors connected to one another such that projectors are capable of communicating with one another, and the display surface indicates projection surfaces to which respective projectors project an image.

12. An information processing apparatus connected to other information processing apparatuses having a display device configured to display an image, the information processing apparatus and the other information processing apparatuses being capable of communicating with one another, the information processing apparatus comprising:
a first display controller configured to control a first display device to display a display target;
a specified position detector configured to detect a position specified by a specifying operation with respect to a display surface of the first display device;
a receiver configured to receive movement of a display position of the display target displayed on the first display device based on the position detected by the specified position detector;
a movement information calculator configured to calculate movement information associated with the movement of the display position of the display target received by the receiver;
a determiner configured to determine whether to transmit display target information associated with the display target and the movement information of the display target to another of information processing apparatuses connected to the information processing apparatus based on the movement information calculated by the movement information calculator; and
a transmitter configured to transmit, when the determiner has determined to transmit the display target to the other information processing apparatus, the display target information and the moving information of the display target to the other information processing apparatus.

13. The information processing apparatus as claimed in claim 12, wherein when the information processing apparatus is a first information processing apparatus, and the other information processing apparatus is a second information apparatus having a second display controller configured to control a second display device to display the display target based on the display target information and the movement information of the display target transmitted by the transmitter,
the first display controller causes the first display device of the first information processing apparatus to stop displaying the display target at a timing at which the displayed display target has reached a second display device of the second information processing apparatus after the transmitter has transmitted the display target information and the movement information of the display target, and
the second display controller causes the second display device of the second information processing apparatus to display the display target based on the display target information at the timing at which the displayed display target has reached the second display device of the second information processing apparatus based on the movement information.

14. The information processing apparatus as claimed in claim 12, wherein
the movement information includes a position, a moving direction, and a moving velocity of the display target.

15. The information processing apparatus as claimed in claim 14, wherein
the determiner determines to transmit the display target information and the movement information to the second information processing apparatus when the moving velocity is greater than or equal to a threshold.

16. The information processing apparatus as claimed in claim 14, wherein when the information processing apparatus is a first information processing apparatus, and the other information processing apparatus is a second information apparatus having a second display controller configured to control a second display device to display the display target based on the display target information and the movement information of the display target transmitted by the transmitter,
the first information processing apparatus further includes a display device specifier configured to specify the second display device being present in the moving direction, wherein
when the display target is present in a determination area predetermined with respect to four sides of the first display device of the first information processing apparatus, the display device specifier determines whether a line extending toward the moving direction intersects one of the four sides with respect to the determination area, and wherein when the line extending toward the moving direction intersects one of the four sides with respect to the determination area, the display device specifier determines a display device adjacent to the side intersected by the line extending toward the moving direction as the second display device present in the moving direction.

17. The information processing apparatus as claimed in claim 14, wherein
the determiner calculates a distance from the display target to an end of the first display device of the first information processing apparatus based on the position and a size of the first display device of the first information processing apparatus, and compares a threshold that is decreased as the distance is reduced and the moving velocity.

18. The information processing apparatus as claimed in claim 12, wherein when the information processing apparatus is the first information processing apparatus, and the other information processing apparatus is the second information apparatus having a second display controller configured to control a second display device to display the display target based on the display target information and the movement information of the display target transmitted by the transmitter,
the first display controller transmits to the second display controller a non-display report indicating that the first display device of the first information processing apparatus has stopped displaying the display target, and
the second display controller causes, after having received the non-display report from the first display controller, the second display device to display the display target based on the display target information and the moving information transmitted by the transmitter.

19. The information processing apparatus as claimed in claim 16, wherein
after the transmitter has transmitted the display target information and the moving information of the display target, the moving information calculator recalculates the moving information,
the display device specifier determines whether the second display device of the second information processing apparatus to which the display target information and the moving information have been transmitted is present in the recalculated moving direction, and
when the second display device of the second information processing apparatus to which the display target information and the moving information have been transmitted is not present in the recalculated moving direction, the transmitter requests the second information processing apparatus to which the display target information and the moving information have been transmitted to stop displaying the display target.

20. A method for displaying an image in a system, the system having a plurality of information processing apparatuses each having a display device configured to display an image, at least two of the information processing apparatuses being capable of communicating with each other, the method comprising:
causing a first display controller to control a first display device of a first information processing apparatus to display a display target;
causing a specified position detector to detect a position specified by a specifying operation with respect to a display surface of the first display device of the first information processing apparatus;
causing a receiver to receive movement of a display position of the display target displayed on the first display device of the first information processing apparatus based on the position detected by the specified position detector;
causing a movement information calculator to calculate movement information associated with the movement of the display position of the display target received by the receiver;
causing a determiner to determine whether to transmit display target information associated with the display target and the movement information of the display target to a second information processing apparatus based on the movement information calculated by the movement information calculator;
causing a transmitter to transmit the display target information and the movement information of the display target to the second information processing apparatus when the determiner has determined to transmit the display target information and the movement information of the display target to the second information processing apparatus; and
causing a second display controller to control a second display device of the second information processing apparatus to display the display target based on the display target information and the movement information of the display target transmitted by the transmitter.
